(19) United States
(12) Patent Application Publication
(10) Pub. No.: US 2025/0073642 A1
(43) Pub. Date: Mar. 6, 2025

(54) MULTI-JET IMPINGEMENT DEHUMIDIFIER FOR MEMBRANE DISTILLATION DESALINATION SYSTEM

(71) Applicant: KING FAHD UNIVERSITY OF PETROLEUM AND MINERALS, Dhahran (SA)

(72) Inventors: Ali Mohammad ALSHEHRI, Dhahran (SA); Atia Esmail KHALIFA, Dhahran (SA)

(73) Assignee: KING FAHD UNIVERSITY OF PETROLEUM AND MINERALS, Dhahran (SA)

(21) Appl. No.: 18/582,954

(22) Filed: Feb. 21, 2024

Related U.S. Application Data
(60) Provisional application No. 63/579,149, filed on Aug. 28, 2023.

(51) Int. Cl. B01D 61/36; B01D 5/00; B01D 63/06; B01D 63/08; B01D 69/02; C02F 1/44; C02F 103/08

(52) U.S. Cl. CPC B01D 61/3641; B01D 5/0027; B01D 61/366; B01D 63/06; B01D 63/08; B01D 69/02; C02F 1/447; B01D 2325/38; C02F 2103/08

(57) ABSTRACT

A water desalination system including a sweeping gas membrane distillation (SGMD) unit in integration with a Jet Impingement Condenser (JIC) unit. The SGMD unit includes a water heater and a water pump connected through an inlet and an outlet to a semi-permeable membrane placed inside a distillation unit. The SGMD unit further includes an air compressor coupled to a humidity sensor, a pressure gauge, a temperature probe, and a flow meter. The JIC unit includes an air accumulation enclosure with an inlet, an air compressor outlet, and a coolant. The JIC unit further includes a perforated plate, and a condenser surface in contact with a sweeping gas inlet. The water desalination system further includes a power unit connected to the water heater and the coolant.

### CROSS-REFERENCE TO RELATED APPLICATIONS

The present application claims benefit of priority to U.S. Provisional Application No. 63/579,149, filed Aug. 28, 2023, which is incorporated herein by reference in its entirety.

### STATEMENT OF PRIOR DISCLOSURE BY AN INVENTOR

Aspects of the present application were described in master's thesis, “Development of Sweeping Gas Membrane Distillation with Jet Impingement Condenser,” College of Engineering and Physics, King Fahd University of Petroleum and Minerals, which is incorporated herein by reference in its entirety.

### STATEMENT OF ACKNOWLEDGEMENT

Support provided by King Fahd University of Petroleum and Minerals, Dhahran, Saudi Arabia, through funding project #INRE2203 is gratefully acknowledged.

### BACKGROUND

### Technical Field

The present disclosure is directed to a water desalination system, more particularly, the present disclosure relates to system and method for water desalination including a sweeping gas membrane distillation (SGMD) module integrated with a jet impingement condenser (JIC) module.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Water scarcity is one of the most pressing challenges of our time, driven by factors such as population growth, urbanization, and climate change. As freshwater resources become increasingly strained, societies around the world are seeking sustainable and efficient methods to secure reliable water supplies. Desalination, which is the process of removing salts and other minerals from seawater or brackish water, has emerged as a critical technology to augment freshwater resources.

Generally, traditional desalination techniques such as reverse osmosis and thermal distillation already exist, however, they often come with substantial energy costs, significant environmental impacts, and in some cases, produce brine by-products that pose disposal challenges. As a result, there has been an increasing interest in developing more energy-efficient, environmentally friendly, and cost-effective desalination technologies. One promising approach is membrane distillation (MD), a thermal desalination process that leverages a hydrophobic membrane which is also vapor permeable and liquid impermeable, so as to separate salts and other contaminants from water.

Among various membrane distillation (MD) configurations, such as, direct contact membrane distillation (DCMD), air gap membrane distillation (AGMD), sweeping gas membrane distillation (SGMD), and vacuum membrane distillation (VMD), the most efficient results have been observed in sweeping gas membrane distillation (SGMD). In SGMD, a hot feed stream and a sweeping gas stream are separated by a hydrophobic, vapor permeable, and liquid impermeable membrane. The vapor pressure difference between the hot feed stream side and the sweeping gas side across the membrane causes water vapor of the hot feed stream to travel through the membrane pores and travel to the sweeping gas side. The larger the temperature difference between the feed and sweeping gas sides, the higher the vapor pressure difference, leading to increased water (permeate) flux across the membrane.

In addition to the desalination, there is a need for an energy efficient and modular condenser technology to condense the desalinated water vapors generated by the membrane distillation systems. Traditionally, several condenser/dehumidifier designs have been proposed, such as bubble column, flat plate, and shell-and-tube dehumidifiers to name a few. However, one that stands out due to the efficiency is jet impingement condenser (JIC) design which has been proposed as a compact and efficient condenser design. The JIC achieves better performance compared to traditional condenser designs, especially in a humid air environment.

Accordingly, it is one objective of the present disclosure to provide a desalination system integrating a membrane distillation module such as the sweeping gas membrane distillation (SGMD) module with a condensation module such as the jet impingement condenser (JIC) to enhance the energy efficiency, environmental performance, and cost-effectiveness of water desalination system and method.

### SUMMARY

In an exemplary embodiment, a water desalination system is described. The water desalination system includes a sweeping gas membrane distillation (SGMD) unit. The SGMD unit includes a first compartment comprising a water inlet pipe and a water outlet pipe. A water heater is connected between the water inlet pipe and the water outlet pipe, and a water pump is connected to the water heater. The SGMD unit further includes a membrane having a first surface of the membrane in contact with the water heater. The SGMD unit further includes an air compressor coupled to a humidity sensor, a pressure gauge, a temperature probe, and a flow meter. An air compressor inlet is connected to an air source and the air compressor is in fluid communication with the membrane. The water desalination system further includes a jet impingement condenser (JIC) unit. The JIC unit includes an air accumulation enclosure with an inlet connected to an air compressor outlet. The JIC unit further includes a perforated plate with a surface having a plurality of circular apertures with same diameter and equally spaced on the surface. The perforated plate is in contact with the air accumulation enclosure. The JIC unit further includes a condenser surface in contact with a sweeping gas inlet. The condenser surface is connected to a chiller. A space between the condenser surface and the perforated plate comprises a gas outlet and a water outlet. The water desalination system further includes a connector comprising an elongated cylindrical pipe coupled parallelly to a secondary cylindrical pipe integrated with a vacuum pump, wherein the connector is extending between the humidified air outlet of the sweeping gas membrane distillation unit and the air accumulation inlet of the jet impingement condenser unit, wherein the connector is configured to pass a uniform flow of the humidified air from the sweeping gas membrane distillation unit to the jet impingement condenser unit. The water desalination system further includes a controller having a power sub-unit.

In some embodiments, the water heater is a recirculation water heater.

In some embodiments, a temperature probe and a flow meter are connected to the water heater.

In some embodiments, the membrane is a hydrophobic material.

In some embodiments, the SGMD unit includes at least one of a cylindrical configuration and a flat plate configuration.

In some embodiments, the JIC unit includes at least one of a cylindrical configuration and a flat plate configuration.

In some embodiments, the water desalination system includes a plurality of the SGMD units.

In some embodiments, the plurality of SGMD units are connected in at least one of a series configuration, a parallel configuration, and a series-parallel configuration to provide a multistage distillation configuration.

In some embodiments, the water desalination system includes a plurality of the JIC units.

In some embodiments, the plurality of the JIC units is connected in at least one of a series configuration, a parallel configuration, and a series-parallel configuration to provide a multistage condenser configuration.

In some embodiments, the gas outlet is connected to the air compressor inlet.

In some embodiments, a heat exchanger is connected between the sweeping gas outlet and the air compressor inlet.

In some embodiments, a material of the condenser surface is at least one of a metal, a ceramic, and a plastic.

In some embodiments, the coolant is a thermoelectric coolant.

In another exemplary embodiment, a water desalination method is disclosed. The water desalination method includes circulating water between an inlet and an outlet of a SGMD unit through a water heater, which helps to generate water vapor. The water desalination method further includes passing the water vapor through a membrane of the SGMD unit and generating humidified air by heating incoming air from an air compressor of the SGMD unit using the water vapor. The water desalination method further includes passing the humidified air leaving the SGMD unit to a JIC unit. The water desalination method further includes generating a plurality of jets of air from the humidified air through equally spaced circular apertures on a perforated plate of the JIC unit and circulating a water stream at a distal end of the JIC unit. The cooled water stream is generated using a coolant and circulating against a condenser surface of the JIC unit. The water desalination method further includes generating water and de-humified air as outputs of the JIC from the plurality of jets of air being in contact with the condenser surface.

In some embodiments, the water desalination method includes connecting a plurality of the SGMD units to provide a multistage distillation configuration.

In some embodiments, the water desalination method includes connecting a plurality of the JIC units to provide a multistage condenser configuration.

In some embodiments, the water desalination method includes passing the dehumidified air to the SGMD unit as the incoming air.

In some embodiments, the water desalination method includes performing a heat exchange between the incoming air of the sweeping gas membrane distillation unit and the dehumidified air output of the jet impingement condenser.

In some embodiments, the water desalination method includes powering the water heater and the coolant through a power unit.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic block diagram illustrating a water desalination system integrating a sweeping gas membrane distillation (SGMD) unit and a jet impingement condenser (JIC) unit, according to certain embodiments;

FIG. 2 is a schematic diagram illustrating various components such as temperature probes and flow meters for the water desalination system of FIG. 1, according to certain embodiments;

FIG. 3 illustrates an exploded view of the SGMD unit of the water desalination system of FIG. 1, according to certain embodiments;

FIG. 4 illustrates an exploded view of the JIC unit of the water desalination system of FIG. 1, according to certain embodiments;

FIG. 5A is a schematic perspective view of a cylindrical configuration of the SGMD unit of the water desalination system of FIG. 1, according to certain embodiments;

FIG. 5B is a schematic perspective view of a flat plate configuration of the SGMD unit of the water desalination system of FIG. 1, according to certain embodiments;

FIG. 6A is a schematic perspective view of a cylindrical configuration of the JIC unit of the water desalination system of FIG. 1, according to certain embodiments;

FIG. 6B is a schematic perspective view of a flat plate configuration of the JIC unit of the water desalination system of FIG. 1, according to certain embodiments;

FIG. 7 is a pictorial representation of a working prototype and various components of a water desalination system, according to certain embodiments;

FIG. 8 is a schematic block diagram of a workflow of a water desalination system, according to certain embodiments.

FIG. 9 is an exemplary flowchart of a method of desalination of water using the water desalination system of FIG. 1, according to certain embodiments;

FIG. 10 is a schematic diagram of a water-cooled, single-stage, single-pass water desalination system, according to certain embodiments;

FIG. 11 is a schematic diagram of a water-cooled, single-stage, multi-pass water desalination system, according to certain embodiments;

FIG. 12 is a schematic diagram of a water-cooled, multi-stage, multi-pass water desalination system configured in parallel configuration, according to certain embodiments;

FIG. 13 is a schematic diagram of a water-cooled, multi-stage, multi-pass water desalination system configured in series configuration, according to certain embodiments;

FIG. 14 is a schematic diagram of an air-cooled, single-stage, single-pass water desalination system, according to certain embodiments;

FIG. 15 is a schematic diagram of a thermoelectrically cooled single-stage, single-pass water desalination system, according to certain embodiments;

FIG. 16 is an exploded view of a jet impingement thermoelectric condenser (JITEC) of the water desalination system of FIG. 15, according to certain embodiments;

FIG. 17 is a schematic diagram of a water desalination system integrating a solar energy source for providing heating for the feed water and the JITEC for cooling humidified air, according to certain embodiments;

FIG. 18 depicts a bar graph illustrating condensation rate with respect to an aperture-to-surface distance of the JIC unit of the water desalination system of FIG. 1, according to certain embodiments;

FIG. 19A depicts a bar graph illustrating permeate flux values, at 25° C. of coolant temperature, with respect to the aperture-to-surface distance at 1.5 mm aperture diameter, according to certain embodiments;

FIG. 19B depicts a bar graph illustrating the permeate flux values, at 25° C. of coolant temperature, with respect to the aperture-to-surface distance at 2.5 mm aperture diameter, according to certain embodiments;

FIG. 19C depicts a bar graph illustrating the permeate flux values, at 25° C. of coolant temperature, with respect to the aperture-to-surface distance at 3.5 mm aperture diameter, according to certain embodiments;

FIG. 20A depicts a bar graph illustrating specific thermal energy consumption (STEC) values, at 25° C. of coolant temperature, with respect to the aperture-to-surface distance at 1.5 mm aperture diameter, according to certain embodiments;

FIG. 20B depicts a bar graph illustrating the specific thermal energy consumption values, at 25° C. of coolant temperature, with respect to the aperture-to-surface distance at 2.5 mm aperture diameter, according to certain embodiments;

FIG. 20C depicts a bar graph illustrating the specific thermal energy consumption values, at 25° C. of coolant temperature, with respect to the aperture-to-surface distance at 3.5 mm aperture diameter, according to certain embodiments;

FIG. 21A depicts a bar graph illustrating the permeate flux values, at 15° C. of coolant temperature, with respect to the aperture-to-surface distance at 1.5 mm aperture diameter, according to certain embodiments;

FIG. 21B depicts a bar graph illustrating the permeate flux values, at 15° C. of coolant temperature, with respect to the aperture-to-surface distance at 2.5 mm aperture diameter, according to certain embodiments;

FIG. 21C depicts a bar graph illustrating the permeate flux values, at 15° C. of coolant temperature, with respect to the aperture-to-surface distance at 3.5 mm aperture diameter, according to certain embodiments;

FIG. 22A depicts a bar graph illustrating the specific thermal energy consumption values, at 15° C. of coolant temperature, with respect to the aperture-to-surface distance at 1.5 mm aperture diameter, according to certain embodiments;

FIG. 22B depicts a bar graph illustrating the specific thermal energy consumption values, at 15° C. of coolant temperature, with respect to the aperture-to-surface distance at 2.5 mm aperture diameter, according to certain embodiments;

FIG. 22C depicts a bar graph illustrating the specific thermal energy consumption values, at 15° C. of coolant temperature, with respect to the aperture-to-surface distance at 3.5 mm aperture diameter, according to certain embodiments;

FIG. 23A depicts a bar graph illustrating the permeate flux values, at 5° C. of coolant temperature, with respect to the aperture-to-surface distance at 1.5 mm aperture diameter, according to certain embodiments;

FIG. 23B depicts a bar graph illustrating the permeate flux values, at 5° C. of coolant temperature, with respect to the aperture-to-surface distance at 2.5 mm aperture diameter, according to certain embodiments;

FIG. 23C depicts a bar graph illustrating the permeate flux values, at 5° C. of coolant temperature, with respect to the aperture-to-surface distance at 3.5 mm aperture diameter, according to certain embodiments;

FIG. 24A depicts a bar graph illustrating the specific thermal energy consumption values, at 5° C. of coolant temperature, with respect to the aperture-to-surface distance at 1.5 mm aperture diameter, according to certain embodiments;

FIG. 24B depicts a bar graph illustrating the specific thermal energy consumption values, at 5° C. of coolant temperature, with respect to the aperture-to-surface distance at 2.5 mm aperture diameter, according to certain embodiments;

FIG. 24C depicts a bar graph illustrating the specific thermal energy consumption values, at 5° C. of coolant temperature, with respect to the aperture-to-surface distance at 3.5 mm aperture diameter, according to certain embodiments;

FIG. 25 depicts a bar graph illustrating an overall permeate flux of the SGMD unit and the JIC unit of the water desalination system, according to certain embodiments;

FIG. 26A depicts a graph illustrating the influence of feed temperature variation on permeate flux of the water desalination system of FIG. 1, according to certain embodiments;

FIG. 26B depicts a graph illustrating the influence of feed temperature variation on gained output ratio (GOR) of the water desalination system of FIG. 1, according to certain embodiments;

FIG. 26C depicts a graph illustrating the influence of feed temperature variation on specific energy consumption (SEC) of the water desalination system of FIG. 1, according to certain embodiments;

FIG. 27A depicts a graph illustrating the influence of feed flow rate variation on permeate flux of the water desalination system of FIG. 1, according to certain embodiments;

FIG. 27B depicts a graph illustrating the influence of feed flow rate variation on gained output ratio of the water desalination system of FIG. 1, according to certain embodiments;

FIG. 27C depicts a graph illustrating the influence of feed flow rate variation specific energy consumption of the water desalination system of FIG. 1, according to certain embodiments;

FIG. 28A depicts a graph illustrating the influence of air flow rate variation on permeate flux of the water desalination system of FIG. 1, according to certain embodiments;

FIG. 28B depicts a graph illustrating the influence of air flow rate variation on gained output ratio of the water desalination system of FIG. 1, according to certain embodiments;

FIG. 28C depicts a graph illustrating the influence of air flow rate variation specific energy 5 consumption of the water desalination system of FIG. 1, according to certain embodiments;

FIG. 29A depicts a graph illustrating the influence of coolant temperature variation on permeate flux of the water desalination system of FIG. 1, according to certain embodiments;

FIG. 29B depicts a graph illustrating the influence of coolant temperature variation on gained output ratio of the water desalination system of FIG. 1, according to certain embodiments;

FIG. 29C depicts a graph illustrating the influence of coolant temperature variation specific energy consumption of the water desalination system of FIG. 1, according to certain embodiments;

FIG. 30A depicts a graph illustrating the influence of coolant flow rate variation on permeate flux of the water desalination system of FIG. 1, according to certain embodiments;

FIG. 30B depicts a graph illustrating the influence of coolant flow rate variation on gained output ratio of the water desalination system of FIG. 1, according to certain embodiments;

FIG. 30C depicts a graph illustrating the influence of coolant flow rate variation specific energy consumption of the water desalination system of FIG. 1, according to certain embodiments;

FIG. 31A depicts a graph illustrating the influence of aperture diameter variation on permeate flux of the water desalination system of FIG. 1, according to certain embodiments;

FIG. 31B depicts a graph illustrating the influence of aperture diameter on gained output ratio of the water desalination system of FIG. 1, according to certain embodiments;

FIG. 31C depicts a graph illustrating the influence of aperture diameter variation specific energy consumption of the water desalination system of FIG. 1, according to certain embodiments;

FIG. 32A depicts a graph illustrating the influence of aperture-to-surface distance variation on permeate flux of the water desalination system of FIG. 1, according to certain embodiments;

FIG. 32B depicts a graph illustrating the influence of aperture-to-surface distance on gained output ratio of the water desalination system of FIG. 1, according to certain embodiments; and

FIG. 32C depicts a graph illustrating the influence of aperture-to-surface distance variation specific energy consumption of the water desalination system of FIG. 1, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values there between.

Aspects of the present disclosure are directed to a water desalination system and a method for desalination. The water desalination system integrates a sweeping gas membrane distillation (SGMD) unit and a jet impingement condenser (JIC) unit (and thus, hereinafter, sometimes, interchangeably referred to as “integrated system” without any limitations). The water desalination method (and thus, hereinafter, sometimes, interchangeably referred to as “integrated method” without any limitations) is an implementation of water desalination using the water desalination system. Firstly, the water desalination system in the present disclosure integrates a sweeping gas membrane distillation unit (SGMD) and a jet impingement condenser (JIC) with an improved membrane cell to condenser connection for an efficient air to condenser, heat, and mass transfer. The membrane of the SGMD unit allows a flow of water from only a feed side of the membrane, with the other side of the membrane in contact with a sweeping gas that delivers evaporated water vapor/air into a JIC condenser through a connector. The connector is a conduit, with a vacuum pump, connecting the gas outlet of the SGMD unit to the air inlet of the JIC unit for a controlled flow of humid air from the membrane cell to the JIC condenser. The JIC condenser has the most efficient heat and mass transfer using the power of jet impingement. Secondly the water desalination system of the present disclosure enhances the overall energy efficiency and modularity of the integrated system by leveraging the compact size and form factor of the integrated system, owing to the small size of the JIC unit. Thirdly, the water desalination method potentially reduces the levelized cost of the process by combining two operations into the integrated method, saving on equipment and operational costs. Lastly, by leveraging a vast selection of available designs for the integrated system, it is particularly suitable for applications in small to medium scale water desalination plants, as the integrated system may be manufactured as per the needs of a particular water desalination plant.

Although the water desalination system, integrating the JIC unit and the SGMD unit, shows great promise, it also poses new challenges. The integrated system needs to be carefully designed and optimized to ensure the efficient condensation of the water vapors. The present disclosure addresses these challenges and presents novel, optimized designs for the water desalination system integrating the JIC unit and the SGMD unit, as discussed hereinafter.

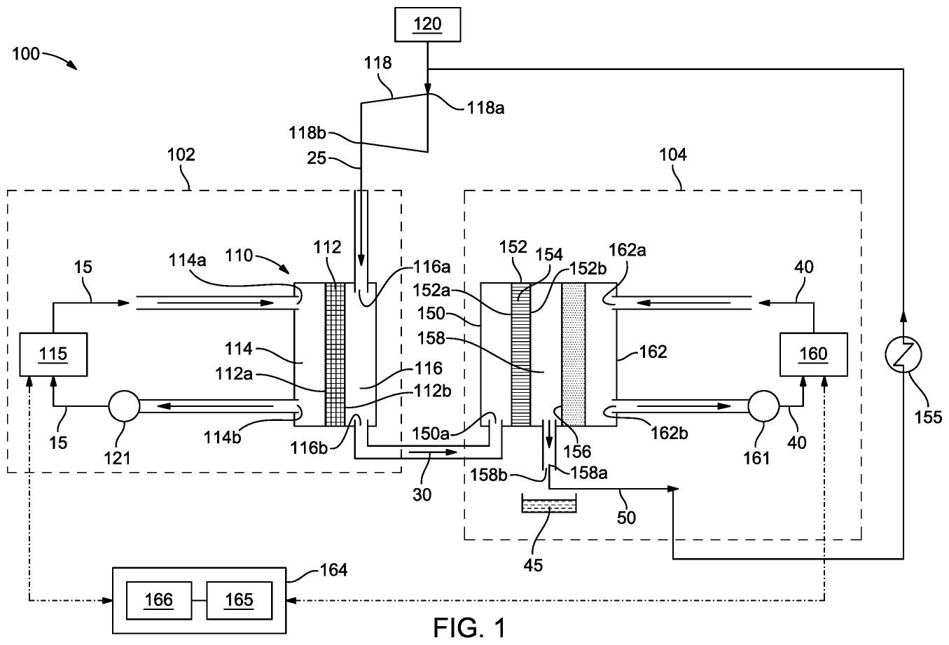

Referring to FIG. 1, a schematic block diagram of a water desalination system 100 is illustrated, according to an embodiment of the present disclosure. The water desalination system 100 is alternatively referred to as ‘the system 100’ for the sake of brevity in explanation. The system 100 includes a sweeping gas membrane distillation (SGMD) unit 102 and a jet impingement condenser (JIC) unit 104. The SGMD unit 102 includes an enclosure 110, and a membrane 112 disposed within the enclosure 110 to define a first space 114, alternatively referred to as ‘the first compartment 114’ and a second space 116, alternatively referred to as ‘the second compartment 116’. As such, the first compartment 114 and the second compartment 116 within the enclosure 110 are separated by the membrane 112. In an embodiment, the membrane 112 is made of hydrophobic material. Hydrophobic is defined as a property of a substance that repels water. In an embodiment, the membrane 112 has low thermal conductivity properties to reduce heat loss. In an embodiment, the membrane 112 is made of a material with low thermal conductivity and hydrophobic properties, such as, for example, polytetrafluoroethylene (PTFE), PCTFE (polychlorotrifluoroethylene) or FEP (fluorinated ethylene propylene), any of which are employed to reduce heat loss. Additionally, the membrane has a pore shape suitable for a low liquid entry pressure. The membrane 112 is also generally resistant to chemicals, such as acids or bases, and exhibits strong thermal stability in a wide range of temperatures. In an embodiment, the membrane 112 is coupled to a membrane support (not shown in FIG. 1) to protect the membrane from deformation. The membrane support includes apertures. Accordingly, the hydrophobic membrane 112 of the present disclosure is configured to allow water vapor and gases to pass therethrough, as the membrane 112 is semi-permeable in nature. The first compartment 114 includes an inlet 114a and an outlet 114b configured to fluidly communicate with a water heater 115. The inlet 114a and the outlet 114b of the first compartment 114 are alternatively referred to as ‘the feed water inlet 114a’ and the ‘feed water outlet 114b’, respectively. The water heater 115 is connected between the feed water inlet 114a and the feed water outlet 114b of the first compartment 114, creating a first recirculation of water. The first recirculation may utilize a water pump, also referred to as a recirculating pump. As such, the water heater 115 is in a fluid communication with the membrane 112.

The second compartment 116 includes a gas inlet 116a and a gas outlet 116b. The gas inlet 116a and the gas outlet 116b are alternatively referred to as ‘the dehumidified air inlet 116a’ and ‘the humidified air outlet 116b’, respectively, without any limitations hereinafter. The system 100 further includes an air compressor 118 configured to couple with the gas inlet 116a of the second compartment 116. In particular, an air compressor inlet 118a of the air compressor 118 is configured to connect to an air source 120 and an air compressor outlet 118b of the air compressor 118 is configured to couple with the gas inlet 116a of the second compartment 116. In an example, the air source 120 may be a compressed air source 120. In an example, the air source 120 may be air from the environment. The air compressor 118 is further configured to be in fluid communication with the membrane 112. According to the present disclosure, at the first surface 112a of the membrane 112, a feed water (designated by a reference numeral 15), such as, for example seawater that requires desalination, is circulated using a water pump 121, which is connected to the water heater 115, to create a hot feed stream 15 that may contact a hydrophobic surface of the membrane 112. At the second surface 112b of the membrane 112, a carrier gas (designated by a reference numeral 25) is pumped to flow in the second compartment 116. In an example, the carrier gas 25 is atmospheric air. Due to a temperature difference across the first surface 112a and the second surface 112b of the membrane 112 from a temperature difference between the feed water 15 and the carrier gas 25, an induced vapor pressure difference is created at the membrane 112. As a result of this potential, water vapor is generated from the feed water 15. This water vapor permeates from hot feed water side (or the first surface 112a) of the membrane 112 in the first compartment 114, into the air side (or the second surface 112b) of the membrane 112 in the second compartment 116. Water vapor crossing the membrane 112 humidifies the air stream in the second compartment 116. Thus, the SGMD unit 102 is acting as a desalination (separation) unit as well as a humidifier. The humidified air stream (designated by a reference numeral 30) is further connected to the JIC unit 104 of the system 100. The connection between the SGMD unit 102 and the JIC unit 104 is driven by a compressor or a vacuum pump. The humidified air stream 30 is passed through a conduit for a controlled pass through of the humidified air stream 30 to the JIC unit 104. The JIC unit 104 includes an air accumulation enclosure 150 having an inlet 150a configured to couple with the gas outlet 116b of the second compartment 116 of the SGMD unit 102. The JIC unit 104 further includes a perforated plate 152 configured to be in contact with the air accumulation enclosure 150. The perforated plate 152 includes a surface with a plurality of perforations 154 (shown as horizontal lines on the perforated plate 152 herein for simplicity). Different geometrical shapes of perforations 154 may be used, such as, for example, cylindrical, circular, conical, or any other shape, for the perforated plate 152 of the JIC unit 104. In particular, the perforated plate 152 includes a first surface 152a configured to be in contact with the air accumulation enclosure 150 and a second surface 152b. The plurality of perforations 154 is defined across a thickness of the perforated plate 152 defined by the first surface 152a and the second surface 152b. The plurality of perforations 154 have same diameters and equally spaced on the surface. The JIC unit 104 further includes a condenser surface 156 disposed proximal to the second surface 152b of the perforated plate 152. In an example, the condenser surface 156 has a flat surface. In an example, the condenser surface 156 has a conical surface. The sweeping gas inlet 150a may be alternatively referred to as ‘the inlet 150a’ of the air accumulation enclosure 150. The condenser surface 156 and the perforated plate 152 are together configured to define a space 158 therebetween, alternatively referred to as ‘the third compartment 158’, or ‘the distillate collection space 158’, is defined between the second surface 152b of the perforated plate 152 and the condenser surface 156. In certain embodiments, the condenser surface 156 may be manufactured using, but not limited to, at least a metal, a ceramic, and a plastic. However, a more preferable material for the condenser surface 156 is a highly conductive metal like copper, aluminum, and the like. The third compartment 158 includes a sweeping gas outlet 158a and a water outlet 158b. In an aspect, the sweeping gas outlet 158a of the third compartment 158 is connected to the inlet 118a of the air compressor 118. Further, the system 100 further includes a heat exchanger 155, connected in between the sweeping gas outlet 158a of the third compartment 158 and the inlet 118a of the air compressor 118. The heat exchanger 155 is in thermal communication with the third compartment 158 and the air compressor 118. The JIC unit 104 further includes a chiller 160 having a coolant (designated by a reference numeral 40) connected to the condenser surface 156. The chiller 160 operates on a cooling mechanism to have the coolant 40 at a desired temperature, such as, brine water cooled, chilled water cooled, thermoelectric cooler or air-cooled cooling mechanisms. The coolant 40 is pumped by a coolant pump 161. In particular, the JIC unit 104 includes a coolant compartment 162 having a coolant inlet 162a and a coolant outlet 162b configured to fluidly communicate with the chiller 160. The coolant compartment 162 is further configured to fluidly communicate with the condenser surface 156. In some aspects, the coolant 40 present in the coolant compartment 162 may be a thermoelectric coolant. In general, thermoelectric coolant refers to a doped semiconductor material essentially taking the place of the liquid or fluid coolant, the cooling effect is produced as a result of current flowing between two semiconductor materials producing heating effect at one end and cooling effect at the opposite end. Some of the doped semiconductor materials used for thermoelectric coolant include bismuth telluride, lead telluride, silicon-germanium, and bismuth antimonide alloys. The humidified air 30 exiting the SGMD unit 102 enters the air accumulation enclosure 150 and is allowed to exit the air accumulation enclosure 150 through the plurality of perforations 154 provided in the perforated plate 152 to create jets. The plurality of perforations 154 are generally shaped as a plurality of circular apertures so as to produce jets of air from the humidified air 30 that is allowed to exit through the plurality of circular apertures 154 on the perforated plate 152. Each of the plurality of perforations may also have a conical shape or a cylindrical shape. The cylindrical apertures are similar to the circular apertures in regards to the aperture diameter, although the cylindrical apertures have an increased depth as compared to the circular apertures resulting in the perforated plate 152 with cylindrical apertures to have an increased lateral thickness as compared to perforated plate 152 with circular apertures. The conical apertures have a wide end of the conical shape towards a first side (towards the air accumulation compartment) of the perforated plate 152 and a narrow end of the conical shape of the apertures on a second side (towards the condenser surface) of the perforated plate 152. The parameters of each aperture, such as, the aperture diameter, the aperture spacing distance and the aperture-to-surface distance impact the generation of jets from the perforated plate 152. Preferably, aperture diameter of each aperture of the plurality of circular apertures 154 is the same with an equal spacing in between the apertures to generate a uniform flow of a multiple jets. In one embodiment the apertures are spaced at an irregular density across the surface of the perforated plate to better accommodate an even flow of jetted humidified air onto the cooling surface. For a square or rectangular perforated plate, the apertures are preferably arranged in a rectangular matrix as a series of nested rectangles where each rectangle of apertures is a line of apertures with horizontal and vertical portions parallel to the vertical and horizontal edges of the perforated plate. The aperture pitch (i.e., number of apertures per linear measure increases as rectangles pf apertures nears the center of the perforated plate, e.g., the pitch increases by 5-20%, or 10-15% for each successive rectangle of apertures. The jets exiting the air accumulation enclosure 150 impinge the condenser surface 156. The condenser surface 156 is cooled by circulating the coolant 40, or the chilled water, on its other side. As the temperature of the condenser surface 156 is below the dew point of the incoming jet, water vapor is generated that condenses, and the air is dehumidified. The condenser surface 156 is generally made of a highly conductive metallic material to promote conduction i.e., heat transfer between the jets of humid air and the coolant 40 across the condenser surface 156 so as to condense the jets of humid air. The highly conductive metallic material for the condenser surface 156 is generally selected from, but not limited to, stainless steel, copper alloys, or titanium, depending on various selection parameters such as the thermal conductivity and corrosion resistance of the condenser surface. The condenser surface 156 is typically treated to increase contact angle between incoming jets of humid air and the condenser surface to promote condensation. Surface roughness is a component of surface texture, it is generally determined by looking at deviations from the normal (mean line) profile of the surface. If these deviations are large the surface is rough, if they are small the surface is smooth. Generally, the surface roughness includes macro-scale roughness, micro-scale roughness or nano-scale roughness, and/or a combination of two or all three types of surface roughness. Surface roughness includes adding features of a defined length (Macro-scale roughness: length between 1 mm to 10 μm, micro-scale roughness: length between 1 and 10 μm, nano-scale roughness: length below 1 μm) on the condenser surface. In an example, the features of the surface roughness include a plurality of outward conical projections throughout the exposed condenser surface 156. The plurality of outward conical projections may have a wide end of the conical projections in contact with the condenser surface 156 and a narrow end of the conical projections away from the condenser surface 156. The conical projections may have a base diameter of 0.05 to 5 mm, preferably 0.1 to 1 mm or about 0.5 mm. The conical projections preferably extend a height (e.g., extend from the base) of 0.5 to 5 times the diameter of the base and preferably extend about the same height as the diameter of the base. The conical projections may be densely formed on the condensation surface such that each conical projection is spaced from all neighboring conical projections by a distance of at least 2 times, preferably 3 times and no more than 5 times, the diameter measured from a center point of the base of the conical projection. An increase in the contact angle between incoming jets of humid air and the condenser surface from upper side to the lower side of the condenser surface 156 can promote condensation and rolling down of the product of condensation. This may be achieved by accordingly structuring the surface starting with macro-scale features, followed by micro-scale features and then nano-scale features from the upper side towards the lower side of the condenser surface 156. In an example, it may be achieved by arranging the outward conical projections in decreasing height of the outward conical projections from the upper side to the lower side of the condenser surface 156.

The product of condensation such as the distillate (designated by a reference numeral 45) (or the freshwater 45) is collected from a bottom of the JIC unit 104 with the help of gravity. The dehumidified air (designated by a reference numeral 50) is directed out of the system 100 through general air flow. The dehumidified air 50 may also be recycled back to the SGMD unit 102 in a second recirculation, fed to the inlet 118a of the air compressor 118. The second recirculation may be driven by a compressor (air pump) or a vacuum pump. In an example, the second recirculation may be through a heat exchanger 155 i.e., the heat exchanger 155 is configured to extract heat from the dehumidified air 50 passing through the sweeping gas outlet 158a before being fed to the inlet 118a of the air compressor 118

The system 100 further includes a power unit 164 connected to the water heater 115 and the chiller 160. In an embodiment, the power unit 164 may include an electric power source 165 configured to supply power to the water heater 115 and the chiller 160, and a controller 166 configured to be in communication with the electric power source 165 and various operating elements of the system 100 such as the water heater 115 and the chiller 160. The controller 166 may be configured to control operations of the water heater 115 and the chiller 160 based on various input parameters. In one example, the input parameters may be set by an operator of the system 100. In another example, the input parameters may be automatically fed into the controller 166 from the water heater 115 and the chiller 160 on real time.

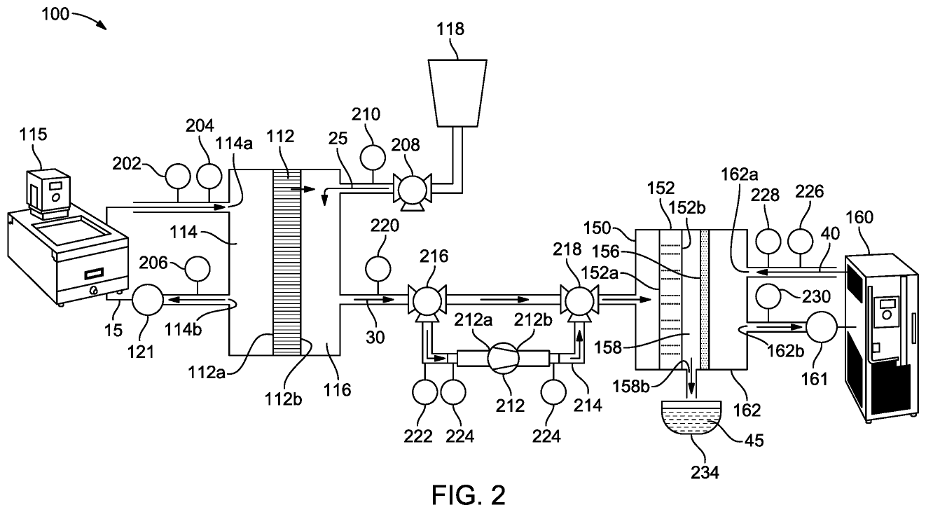

Referring to FIG. 2, a schematic circuit diagram of the system 100 showing various operating elements and instrumentations are illustrated, according to an embodiment of the present disclosure. Referring to FIG. 1 and FIG. 2, the SGMD unit includes the first compartment 114 configured to be in fluid communication with the water heater 115. In an embodiment, the water heater 115 is a recirculation water heater. The water heater 115 is connected to the first compartment 114 of the SGMD unit via the feed water inlet 114a and the feed water outlet 114b through a feedwater inlet conduit and a feed water outlet conduit, respectively. A first flow meter 202 and a first temperature probe 204 are coupled to the feedwater inlet conduit. In an embodiment, the first flow meter 202 and the first temperature probe 204 may be connected to the controller 166 (shown in FIG. 1). The first flow meter 202 is configured to determine a flow rate at which the feedwater 15 is supplied to the SGMD unit from the water heater 115. In an embodiment, the water pump 121 may be controlled to control the flow rate of the feedwater 15. Further, the water pump 121 may be connected to the controller 166 (shown in FIG. 1) such that the operation of the water pump 121 may be controlled. The first temperature probe 204 is configured to determine a temperature of the feedwater 15 supplied to the SGMD unit 102. The water heater 115 may be controlled to control the temperature of the feedwater 15 supplied to the SGMD unit. In an example, the controller 166 (shown in FIG. 1) in communication with the water heater 115 may control the operation of the water heater 115. A second temperature probe 206 is coupled to the feedwater outlet conduit to determine a temperature of the feedwater 15 returned to the water heater 115 from the SGMD unit. In an example, the second temperature probe 206 may also be coupled to the controller 166 (shown in FIG. 1).

The system 100 further includes the second compartment 116 configured to be in communication with the air compressor 118 via a gas inlet conduit. In an embodiment, the air compressor 118 may be communicated with the controller 166 (shown in FIG. 1) such that an operation of the air compressor 118 may be controlled using the controller 166 (shown in FIG. 1). A first three-way valve 208 is disposed in the gas inlet conduit to control a direction of flow of the carrier gas 25 to the SGMD unit. Further, a second flow meter 210 is disposed in the gas inlet conduit to determine a flow rate at which the carrier gas 25 is supplied to the SGMD unit. In an embodiment, the first three-way valve 208 and the second flow meter 210 may be communicated with the controller 166 (shown in FIG. 1) such that the controller 166 may actuate the three-way valve 208 and control operation of the air compressor 118 based on the flow rate determined by the second flow meter 210.

The humidified air 30 exiting the second compartment 116 of the SGMD unit is further communicated with the JIC unit via a connector comprising a vacuum pump 212. The vacuum pump 212 is coupled to a gas outlet conduit parallelly using an auxiliary conduit 214, a second three-way valve 216 and a third three-way valve 218, all these components in combination referred to as a connector. In an embodiment, the dimensions of the auxiliary conduit range from about 0.2 up to 1.5 times the dimensions of the gas outlet conduit The vacuum pump 212 may be communicated with the controller 166 (shown in FIG. 1) such that an operation of the vacuum pump 212 may be controlled to control the flow of the humidified air 30 (or the sweeping gas 30) from the SGMD unit to the JIC unit. Further, the second three-way valve 216 and the third three-way valve 218 may be communicated with the controller 166 (shown in FIG. 1) to control a direction of flow of the humidified air 30. A third temperature probe 220 is coupled to the gas outlet conduit to determine a temperature of the humidified air 30 coming out of the SGMD unit. A third flow meter 222 is coupled to the auxiliary conduit 214 to determine a flowrate of the humidified air 30 and a pair of pressure gauges 224 is coupled to an inlet 212a and an outlet 212b of the vacuum pump 212 to determine a pressure difference across the vacuum pump 212. The third temperature probe 220, the third flow meter 222 and the pair of pressure gauges 224 may be communicated with the controller 166 (shown in FIG. 1) to control the operation of the vacuum pump 212.

The system 100 further includes the chiller 160 configured to be in communication with the coolant compartment 162. The chiller 160 is connected to the JIC unit via the coolant inlet 162a and the coolant outlet 162b through a coolant inlet conduit and a coolant outlet conduit, respectively. A fourth flow meter 226 and a fourth temperature probe 228 are coupled to the coolant inlet conduit. In an embodiment, the fourth flow meter 226 and the fourth temperature probe 228 may be connected to the controller 166 (shown in FIG. 1). The fourth flow meter 226 is configured to determine a flow rate at which the coolant 40 is supplied to the JIC unit from the chiller 160. The coolant pump 161 may be controlled to control the flow rate of the coolant 40. Further, the coolant pump 161 may be connected to the controller 166 (shown in FIG. 1) such that the operation of the coolant pump 161 may be controlled. The fourth temperature probe 228 is configured to determine a temperature of the coolant 40 supplied to the JIC unit. The chiller 160 may be controlled to control the temperature of the coolant 40 suppled to the JIC unit. In an example, the controller 166 (shown in FIG. 1) in communication with the chiller 160 may control the operation of the chiller 160. A fifth temperature probe 230 is coupled to the coolant outlet conduit to determine a temperature of the coolant 40 returned to the chiller 160 from the JIC unit. In an example, the fifth temperature probe 230 may also be coupled to the controller 166 (shown in FIG. 1).

The humidified air 30 received through the sweeping gas inlet of the JIC unit comes in contact with the condenser surface 156, thereby the water vapor and/or water particles in the humidified air 30 condense in the third compartment 158 to produce distilled water 45. The distilled water 45 produced in the third compartment 158 may be collected using a container 234 through the water outlet 158b. The dehumidified air 50 is further exited from the third compartment 158 as shown in FIG. 1. In one embodiment, the sweeping gas outlet 158a may be defined in the third compartment 158 to exit the dehumidified air 50 as shown in FIG. 1. In another embodiment, the dehumidified air 50 may be exited through the water outlet 158b.

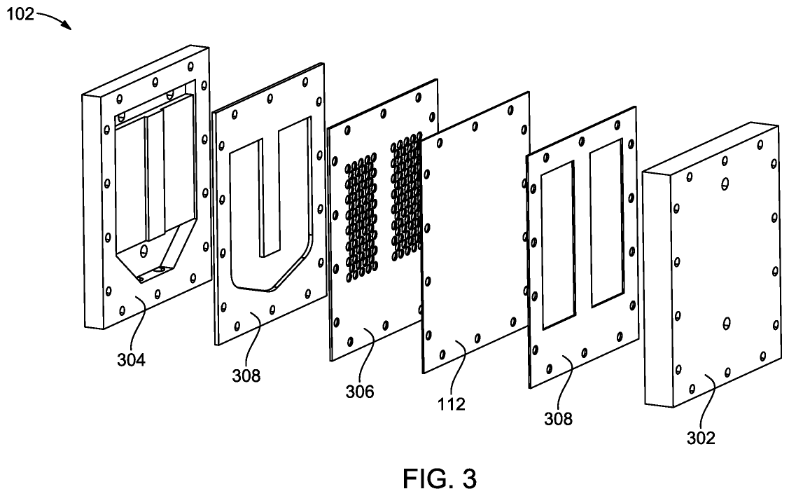

Referring to FIG. 3, an exploded view of the SGMD unit 102 is illustrated, according to an embodiment of the present disclosure. The SGMD unit 102 includes the membrane 112, a feed water channel 302, a sweeping gas channel 304, a membrane support 306, and a pair of gaskets 308. The membrane 112 is sandwiched between the feed water channel 302 and the sweeping gas channel 304. Further, the membrane 112 is rigidly disposed between the feed water channel 302 and the sweeping gas channel 304 using the membrane support 306. Moreover, each of the pair of gaskets 308 is disposed on either side of the membrane 112 to provide a fluid tight coupling between the feed water channel 302 and the sweeping gas channel 304. The feed water channel 302 and the membrane 112 are together configured to define the first compartment 114 for receiving the feedwater 15 therein (shown in FIG. 1). Similarly, the sweeping gas channel 304 and the membrane 112 are together configured to define the second compartment 116 for receiving the carrier gas 25 therein from the air compressor 118 (shown in FIG. 1).

In some embodiments, an area of membrane distillation (MD) module is in a range of about 225×200 mm² up to 1125×1000 mm² while the effective membrane area is in a range of about 0.01 m² up to 0.05 m². The feed water channel 302 has a thickness in a range of about 20 mm up to 150 mm and includes two headers for defining the feed water inlet 114a and the feed water outlet 114b and two channels between the two headers inside the feed water channel 302. The header has a depth in a range of about 5 mm up to 50 mm, width in a range of about 10 mm up to 450 mm, and length in a range of about 10 mm up to 75 mm, while the channels have a depth in a range of about 1 mm up to 15 mm, width in a range of about 20 mm up to 300 mm, and length in a range of about 100 mm up to 600 mm. The header and channel dimensions of the sweeping gas channel 304 are similar to the feed water channel 302. In particular, an exit header of the sweeping gas channel 304 has more depth with extra 4 mm-20 mm, and it has two holes at bottom which may be connected to two ball valves to ensure that any condensate vapor may be collected easily. Using a CNC milling machine, the channels and the headers may be produced. The membrane 112 is surrounded by the membrane support 306 and the pair of gaskets 308 and is placed between hot and cold sides of the MD module. The membrane 112 has micropores besides being hydrophobic. The membrane support 306 may be made of brazing allow and the pair of gaskets 308 may be made of rubber with approximate thickness in a range of about 1 mm up to 4.5 mm and 0.8 mm up to 6 mm, respectively. In an embodiment, the membrane distillation (MD) module may be scaled up to 5, 10 or even 20 times the dimensions as described in the present disclosure. In an embodiment, the membrane distillation (MD) module may be scaled down to 0.1 up to 0.5 times the dimensions as described in the present disclosure.

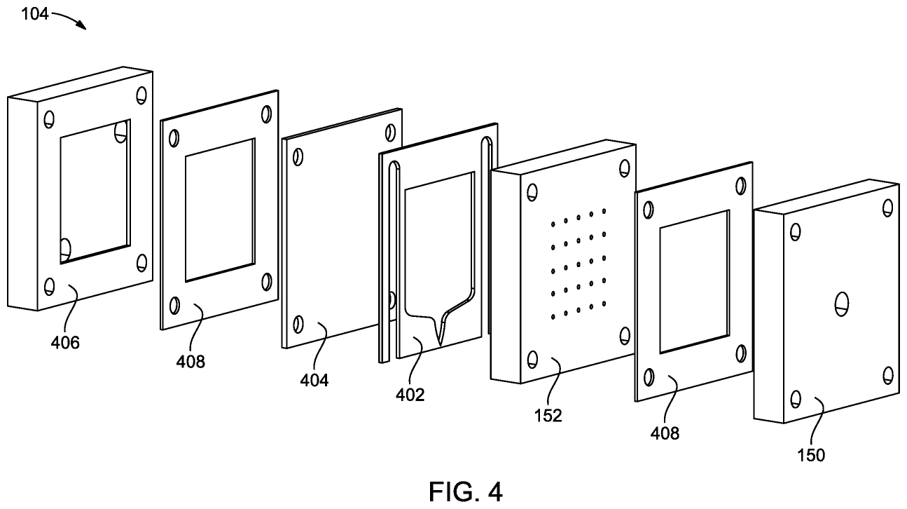

Referring to FIG. 4, an exploded view of the JIC unit is illustrated, according to an embodiment of the present disclosure. The JIC unit is made of the air accumulation enclosure 150, the perforated plate 152, a spacer 402, a copper plate 404, a chilled water channel 406, and a pair of gaskets 408. In an example embodiment of the JIC unit the condenser surface of highly conductive material is chosen as a copper plate 404. One of the pair of gaskets 408 is disposed between the air accumulation enclosure 150 and the perforated plate 152 to provide a fluid tight seal therebetween. The copper plate 404 is disposed to be in close contact with the chilled water channel 406. Further, one of the pair of gaskets 408 is disposed between the chilled water channel 406 and the copper plate 404 to provide fluid tight seal therebetween. The copper plate 404 is further configured to act as the condenser surface 156, according to the present disclosure. Further, the chilled water channel 406 and the copper plate 404 together configured to define the coolant compartment 162. The spacer 402 is disposed between the copper plate 404 and the perforated plate 152 for an efficient aperture-to-surface distance, i.e., aperture-to-condenser surface distance such that the jets are allowed to come in contact with the condenser surface (the copper plate 404) and produce the distilled water 45. The spacer 402 has a rectangular opening (a rectangular cut-out with dimensions same as or slightly bigger than the dimensions of a matrix of the plurality of perforations 154) such as that the plurality of perforations 154 on the perforated plate 152 are exposed to the copper plate 404 for condensation process. The bottom end of the rectangular opening comprises a depressed end (the conical shape) to promote the trickling down of the distilled water 45 generated from the condensation process through inner circumference of the depressed end. The spacer 402, the copper plate 404 and the perforated plate 152 together configured to define the third compartment 158 for collecting the distilled water 45.

In some embodiments, an area of the JIC unit is in a range of about 100×100 mm² up to 1000×1000 mm², while the effective condensation area in a range of about 0.001 m² up to 0.05 m². The air accumulation enclosure 150 has a thickness in a range of about 10 mm up to 200 mm where it has an accumulation area in a range of about 60×60 mm² up to 600×600 mm² with a depth of about 8 mm up to 50 mm. The perforated plate 152 has similar thickness in a range of about 16 mm up to 100 mm and has about 20 up to 125 jet apertures/perforations, generally around 25 jet apertures/perforations with a diameter size in a range of about 1.2 mm up to 4.5 mm, and all the aperture/perforation diameters are defined within the same area of the air accumulation. A distance between one aperture diameter to another aperture diameter is in a range of about 5 mm up to 30 mm. The spacer 402 generally has a varied thickness ranging from 4 mm to 14 mm, generally with a 2 mm difference from each, or from about 20 mm up to 125 mm. The spacer 402 has an exit hole of about 4 mm up to 20 mm diameter approximately at the bottom for each spacer to collect the condensate water vapor. The copper plate 404 has a thickness in a range of about 1 mm up to 4.5 mm, while the chilled water channel 406 has a thickness of about 10 mm up to 100 mm. An area in a range of about 40×40 mm² up to 600×600 mm² with a depth in a range of about 1 mm up to 10 mm are placed in the chilled water channel 406 to let the chilled water pass through it. The pair of gaskets 408 are placed between the air accumulation enclosure 150 and the perforated plate 152, and also between the copper plate 404 and the chilled water channel 406, which has a hollow space in a range of about 50×50 mm² up to 200×200 mm². In an embodiment, the jet impingement condensation (JIC) module may be scaled up to 5, 10 or even 20 times the dimensions as described in the present disclosure. In an embodiment, the jet impingement condensation (JIC) module may be scaled down to 0.1 up to 0.5 times the dimensions as described in the present disclosure.

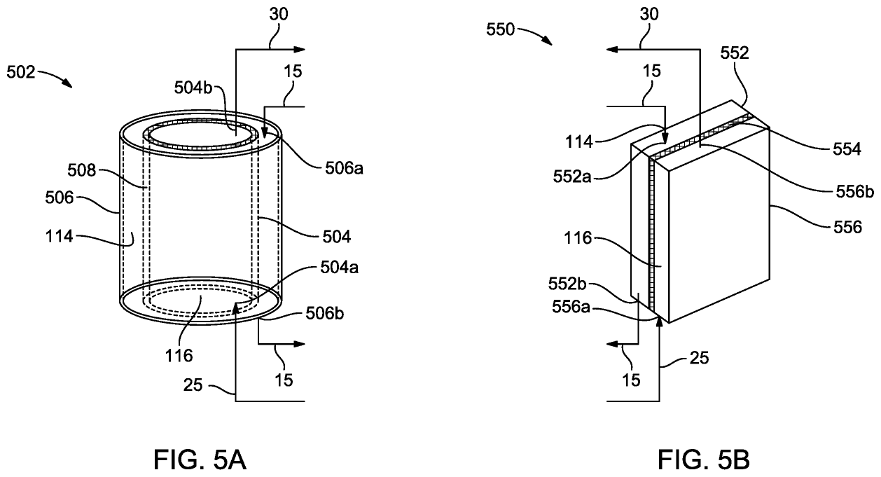

Referring to FIG. 5A and FIG. 5B, various configurations of the SGMD unit 102 of FIG. 1 are illustrated, according to certain embodiments. Referring to FIG. 5A, a cylindrical configuration of a SGMD unit 502, alternatively referred to as ‘the cylindrical SGMD unit 502’, is illustrated. The cylindrical SGMD unit 502 includes a first hollow cylindrical body 504 configured to define the second compartment 116 for receiving the carrier gas 25 from the air compressor 118. Further, the first hollow cylindrical body 504 may include a gas inlet 504a configured to couple with the air compressor 118 and a gas outlet 504b configured to communicate the humidified air 30 with the JIC unit 104. The gas inlet 504a may be defined at a bottom end of the cylindrical SGMD unit 502, and the gas outlet 504b may be defined at a top end of the cylindrical SGMD unit 502. The cylindrical SGMD unit 502 further includes a second hollow cylindrical body 506 surrounding the first hollow cylindrical body 504. The second hollow cylindrical body 506 is configured to define a space, referred to as the first compartment 114. The first compartment 114 defined by the second hollow cylindrical body 506 includes a feed water inlet 506a and a feed water outlet 506b. The cylindrical SGMD unit 502 includes a cylindrical membrane 508 configured to be in contact with the first compartment 114 defined by the second hollow cylindrical body 506 and the second compartment 116 defined by the first hollow cylindrical body 504. According to the present disclosure, a circumferential wall of the first hollow cylindrical body 504 may be made of hydrophobic material and made as semi-permeable membrane. As such, the circumferential wall of the first hollow cylindrical body 504 may be referred to as ‘the cylindrical membrane 508’. The cylindrical membrane 508 spans along a height and circumference of the second hollow cylindrical body 506. The first compartment 114 and the second compartment 116 are separated by the cylindrical membrane 510.

Referring to FIG. 5B, a flat plate configuration of a SGMD unit 550, alternatively referred to as the ‘flat plate SGMD unit 550’, is illustrated. The flat plate SGMD 550 unit includes a first hollow cuboidal body 552. The first hollow cuboidal body 552 is configured to define the first compartment 114. The first compartment 114 is in fluid communication with a feed water inlet 552a and a feed water outlet 552b. The feed water inlet 552a may be defined at the top of the first compartment 114. The feed water outlet 552b may be defined at the bottom of the first compartment 114. Further, the flat plate SGMD unit 550 includes a flat membrane 554. The flat membrane 554 is semi-permeable in nature and allows the water vapor from the first compartment 114 to pass through. Furthermore, the flat plate SGMD unit 550 includes a second hollow cuboidal body 556. The second hollow cuboidal body 556 is configured to define the second compartment 116. The second compartment 116 is in contact with the flat membrane 554 as well as a gas inlet 556a and a gas outlet 556b. The gas outlet 556b is configured to communicate with the JIC unit 104 and the gas inlet 556a is configured to communicate with the air compressor 118.

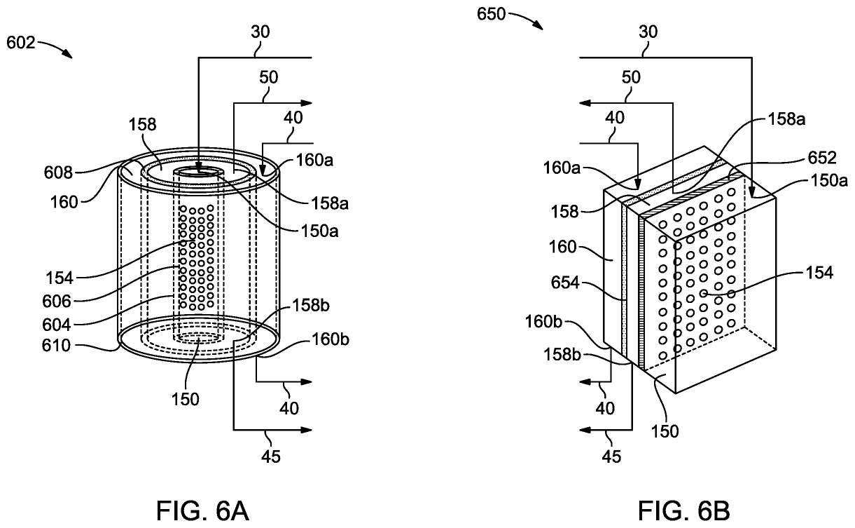

Referring to FIG. 6A and FIG. 6B, various configurations of the JIC unit 104 of FIG. 1 are illustrated, according to certain embodiments. Referring to FIG. 6A, a cylindrical configuration of a JIC unit 602, alternatively referred to as the ‘cylindrical JIC unit 602’, is illustrated. The cylindrical JIC unit 602 includes a first hollow cylindrical body 604. The first hollow cylindrical body 604 is configured to define the air accumulation enclosure 150. The air accumulation enclosure 150 includes the humid air inlet 150a in connected with the gas outlet 116b of the SGMD unit 102 of FIG. 1. A circumferential wall 606 of the first hollow cylindrical body 604 includes a plurality of perforations 154, as such, the circumferential wall 606 is alternatively referred to as the ‘cylindrical perforated plate 606’. The cylindrical perforated plate 606 is configured to be in contact with the air accumulation enclosure 150. The cylindrical perforated plate 606 includes a surface with a plurality of circular apertures, which is otherwise referred to as the plurality of perforations 154. In particular, the cylindrical perforated plate 606 is configured to be in communication with the air accumulation enclosure 150. The plurality of perforations 154, generally described as, circular apertures 154, are defined across a thickness of the cylindrical perforated plate 606 The plurality of circular apertures 154 have same diameters and equally spaced on the surface.

The cylindrical JIC unit 602 further includes a cylindrical condenser surface 608, in the form of a second hollow cylindrical body 608, disposed near the cylindrical perforated plate 606. The cylindrical condenser surface 608 and the cylindrical perforated plate 606 are together configured to define the space 158 therebetween. The third compartment 158 has the dehumidified air outlet 158a configured to be disposed at the top thereof and the water outlet 158b configured to be disposed at the bottom thereof. Furthermore, the cylindrical JIC unit 602 has a third hollow cylindrical body 610 configured to define an outer boundary and a space between the third hollow cylindrical body 610 and the second hollow cylindrical body 608. The space therein is alternatively referred to as the coolant compartment 162. The coolant compartment 162 includes the coolant inlet 160a configured to be disposed at the top thereof and the coolant outlet 160b configured to be disposed at the bottom thereof. The coolant 40 flowing in the coolant compartment 162 is in connection with outer walls of the second hollow cylindrical body 608, thereby cooling the second hollow cylindrical body 608. As such, the walls of the second hollow cylindrical body 608 are at a lower temperature than the dew point of the humidified air 30 coming from the sweeping gas inlet. As a result, the water present in the humidified air 30 is distillated and may be extracted through the water outlet 158b present therein.

Referring to FIG. 6B, a flat plate configuration of a JIC unit 650, alternatively referred to as the ‘flat plate JIC unit 650’, is illustrated. The flat plate JIC unit 650 includes a first hollow cuboidal space, alternatively referred to as the air accumulation enclosure 150. The air accumulation enclosure 150 includes the humid air inlet 150a, disposed at the top of the air accumulation enclosure 150, in connection with the humid air outlet 116b of the SGMD unit 102 therein. The flat plate JIC unit 650 further includes a flat perforated plate 652 configured to be in contact with the air accumulation enclosure 150. The flat perforated plate 652 includes a surface with the plurality of perforations 154, or generally described as, circular apertures 154. In particular, the flat perforated plate 652 is configured to be in communication with the air accumulation enclosure 150. The plurality of circular apertures 154 are defined across a thickness of the flat perforated plate 652. The plurality of circular apertures 154 have same diameters and equally spaced on the surface.

The flat plate JIC unit 650 further includes a flat condenser surface 654 disposed near the flat perforated plate 652. The flat condenser surface 654 and the flat perforated plate 652 are together configured to define the space 158 (or the third compartment 158) therebetween. The third compartment 158 therein has the dehumidified air outlet 158a configured to be disposed at the top thereof and the water outlet 158b configured to be disposed at the bottom thereof. The flat condenser surface 654 is in contact with the coolant compartment 162 and the coolant flowing therein. The coolant compartment 162 is defined by a fourth cuboidal space. The coolant compartment 162 has the coolant inlet 160a configured to be disposed at the top of the coolant compartment 162 and the coolant outlet 160b configured to be disposed at the bottom of the of the coolant compartment 162.

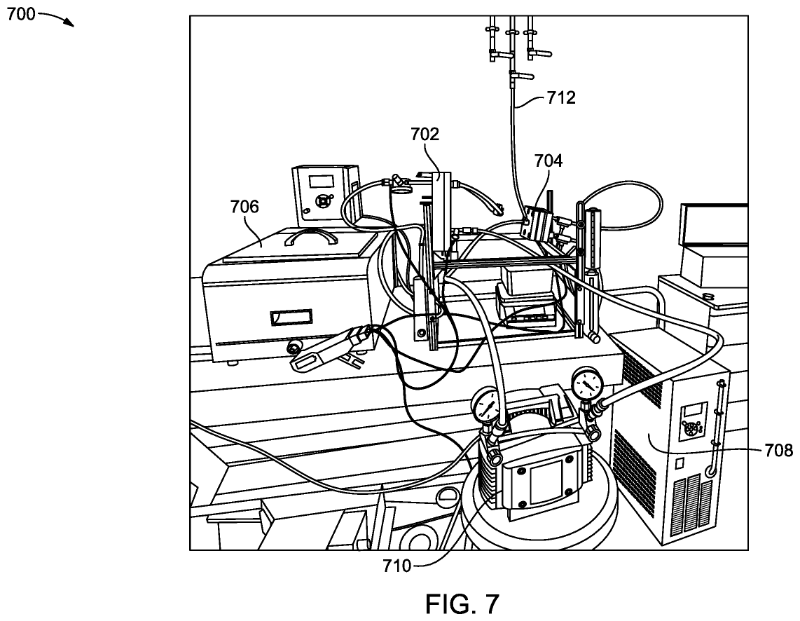

Referring to FIG. 7, a pictorial representation of a water desalination system 700 comprising a SGMD unit 702 in conjunction with a JIC unit 704 is illustrated, according to certain embodiments. The water desalination system 700 has many similarities in terms of components used in the water desalination system 100 of FIG. 1. The water desalination system 700 is a working prototype of the water desalination system 100. The water desalination system 700 includes an electric heater 706 and the SGMD unit 702. The electric heater 706 is in thermal communication with the SGMD unit 702. The SGMD unit 702 has similar internal components as described in FIG. 1. The SGMD unit 702 includes the enclosure 110, and the membrane 112 disposed within the enclosure 110 to define the first compartment 114 and the second compartment 116. As such, the first compartment 114 and the second compartment 116 within the enclosure are separated by the membrane 112. The SGMD unit 702 further includes a sweeping gas chamber in fluid communication with the JIC unit 704. The JIC unit 704 includes the air accumulation enclosure 150, the perforated plate 152, and the condenser surface 156. The condenser surface 156 is in thermal communication with an electric chiller 708. The electric chiller 708 is responsible for cooling the condenser surface 156 below the dew point temperature of the humidified air 30 coming from the SGMD unit 702 to the JIC unit 704. The water desalination system 700 further includes a vacuum pump 710, in pneumatic communication with the SGMD unit 702 and the JIC unit 704. Furthermore, the water desalination system 700 includes a pressurized air source, alternatively referred to as the compressed air 712.

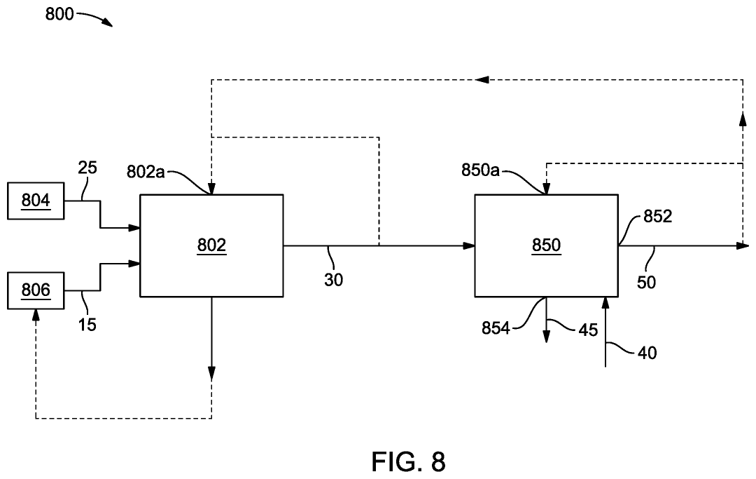

Referring to FIG. 8, a schematic block diagram of a water desalination system 800 is illustrated, in accordance with certain embodiments of the present disclosure. At block 802, system 800 includes the SGMD unit 102, with its key components similar to that of the key components of the water desalination system 100 of FIG. 1. The system 800 includes the air compressor 118, at block 804, for supplying the pressurized air to the block 802. The system 800 further includes the water pump 121 at block 806. The water pump 121 receives the feedwater input from a source and also from the block 802. Further, the humidified air 30 from the block 802 is transferred to the JIC unit 104, at block 850. The SGMD unit 102, at the block 802, further receives recirculated feedwater through a plurality of inlets 802a defined in the SGMD unit 102. At the block 850, the JIC unit 104 includes two outlets, a first outlet 852 for dehumidified air 50 and a second outlet 854 for the distillate 45. The dehumidified air 50 is further recirculated (as aforementioned) to the block 802. Furthermore, the block 850 includes an inlet 850a configured to receive the dehumidified air 50. A more detailed explanation and working of the aforementioned water desalination system 100 is provided, with accompanying figures, in subsequent paragraphs(s).

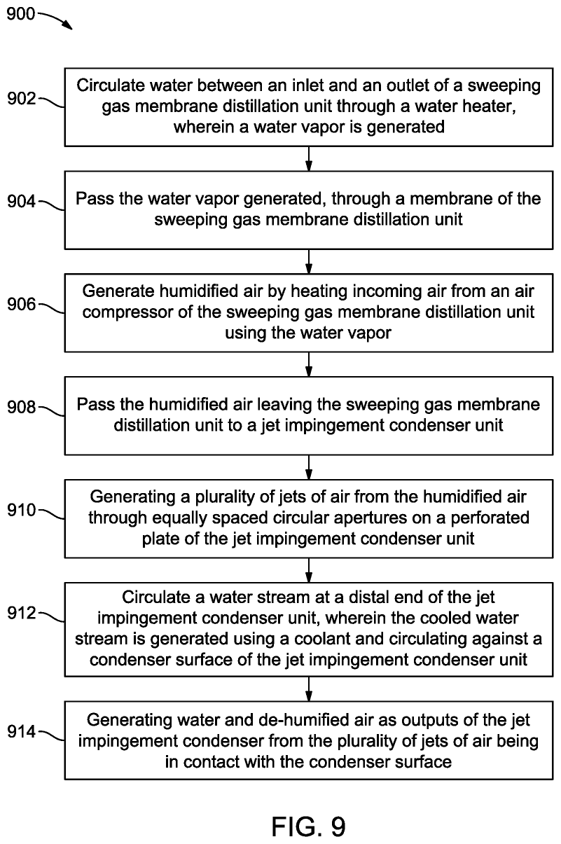

Referring to FIG. 9, a method 900 for desalination of water using the water desalination system 100 is illustrated, according to an embodiment of the present disclosure. The order in which the method 900 is described is not intended to be construed as a limitation, and any number of the described method steps may be combined in any order to implement the method 900. Additionally, individual steps may be removed or skipped from the method 900 without departing from the spirit and scope of the present disclosure. The method 900 of the present disclosure is illustrated with refence to the water desalination system 100 shown in FIG. 1.

At step 902, the method 900 includes circulation of feedwater between the inlet 114a and the outlet 114b of the first compartment 114 of the SGMD unit 102 through the water heater 115, the water heater 10 further heats up the feedwater 15 and inputs the first compartment 114 of the SGMD unit 102. The heated feedwater gets in fluid contact with a membrane 12 to generate water vapors in the first compartment 114. The membrane 112 is disposed between the first compartment 114 and the second compartment 116. The feedwater 15 may refer to at least one of an impure water, seawater, brackish water, brine water. The controller 166 supplies the power to the water heater 115 through the electric power source 165.

At step 904, the method 900 includes passing the water vapors through the membrane 112 of the SGMD unit 102. The membrane 112 is semi-permeable in nature and allows the water vapors to selectively pass through the membrane 112, while, disallowing the impurities (salts, solids) through the membrane 112.

At step 906, the method 900 includes generation of humidified air 30 by heating the incoming air from the air compressor 118, due to the latent heat of the water vapors generated at step 902 and transferred through the membrane 112 to the second compartment 116 at step 904 of the method 900. The air compressor 118 pushes pressurized air through the inlet 116a present in the SGMD unit 102. The pressurized air may be alternatively referred to as the sweeping gas. In an aspect of the present disclosure, the sweeping gas may be inert in nature.

At step 908, the method 900 includes passing the humidified air 30 from the outlet 116b of the SGMD unit 102 to the inlet 150a of the air accumulation enclosure 150 of the JIC unit 104. The air accumulation enclosure 150 is configured to collect the humidified air via the inlet 150a and store the humidified air 30 therein.

At step 910, the method 900 includes generation of the plurality of jets from the humidified air 30 with the help of equally spaced circular apertures 154 present in the perforated plate 152 of the JIC unit 104. The perforated plate 152 is in contact with the air accumulation enclosure 150. The high pressure humidified air 30 present in the air accumulation enclosure 150, when passed through the circular apertures 154, creates the plurality of high-pressured jet of the humidified air containing pure water.

At step 912, the method 900 includes circulation of the plurality of jets (alternatively referred to as the water stream) to a distal end of the JIC unit 104. The JIC unit 104 includes the condenser surface 156 at the distal end of the JIC unit 104. The condenser surface 156 is cooled by the coolant 40, circulating against the condenser surface 156 of the JIC unit 104. The water stream is cooled at the condenser surface 156 present at the distal end of the JIC unit 104.

At step 914, the method 900 includes generation of water (alternatively referred to as the distillate 45) and dehumidified air 50 as outputs of the JIC unit 104. The distillate 45 is generated as the plurality of jets of the humidified air 30, being in contact with the condenser surface 156, were cooled below the dew point temperature of the humidified air 30.

In some aspects, to further increase the efficiency of the water desalination system 100, the dehumidified air 50 from the JIC unit 104 is recirculated to the SGMD unit 102, and the air compressor 118 therein, as input air. Further, the pathway from the JIC unit 104 to the SGMD unit 102 for the dehumidified air 50 includes the heat exchanger 155 as shown in FIG. 1. The heat exchanger 155 may serve as a pre-cooler for the air entering the air compressor 118 and subsequently the SGMD unit 102. Since cooler air is denser, the air carrying capacity of the SGMD unit 102 is increased. The heat exchanger 155 serves as an efficiency enhancing device, by pre-cooling the air, it increases the air carrying capacity of the water desalination system 100.

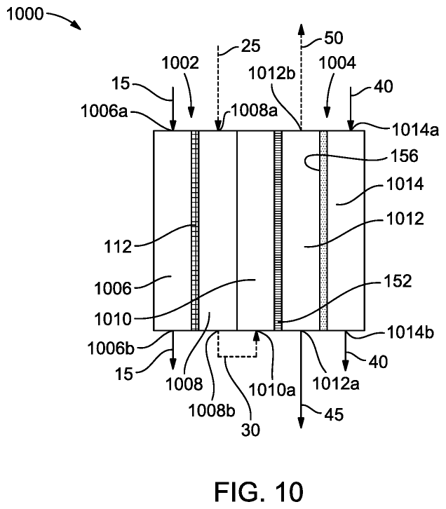

Referring to FIG. 10, a schematic diagram of a water-cooled, single-stage, single-pass water desalination system 1000 is illustrated, according to certain embodiments. The water desalination system 1000 includes a SGMD unit 1002 and a JIC unit 1004. The SGMD unit 1002 of the water desalination system 1000 includes a feed chamber 1006 with a feed inlet 1006a, disposed at the top of the feed chamber 1006 and a feed outlet 1006b disposed at the bottom of the feed chamber 1006. The feed inlet 1006a and the feed outlet 1006b are in fluid communication with the feed chamber 1006. The feed chamber 1006 receives feed water 15 through the feed inlet 1006a. The feed water 15 is then passed through the membrane 112. The water desalination system 1000 further includes a sweeping gas chamber 1008. The membrane 112 is disposed between the feed chamber 1006 and the sweeping gas chamber 1008. The sweeping gas chamber 1008 includes a sweeping gas inlet 1008a, disposed at the top of the sweeping gas chamber 1008 and a sweeping gas outlet 1008b disposed at the bottom of the sweeping gas chamber 1008. The sweeping gas inlet 1008a and the sweeping gas outlet 1008b are in fluid communication with the sweeping gas chamber 1008. Further, the JIC unit 1004 of the water desalination system 1000 includes an air accumulation enclosure 1010, receiving a stream of the humidified air 30 from the SGMD unit 1002, through an inlet 1010a. The air accumulation enclosure 1010 acts as a hollow container to hold the contents coming from the SGMD unit 1002. The inlet 1010a and the air accumulation enclosure 1010 are in fluid communication. The water desalination system 1000 further includes the perforated plate 152 having equidistant circular apertures 154. In some embodiments, the apertures may be of any other shape including, but not limited to, triangular apertures, square apertures.

The water desalination system 1000 further includes a compartment 1012. The concentrated jet impinged humidified air 30 is introduced into the compartment 1012 via the perforated plate 152. The aforementioned concentrated humidified air 30 comes in contact with the condenser surface 156. The condenser surface 156 is cooled and is at a lower temperature than the dew point of the concentrated humidified air 30. The low temperature of condenser surface 156 facilitates the condensation of water vapor from the concentrated humidified air 30. The compartment 1012 includes a freshwater outlet 1012a disposed at the bottom of the compartment 1012. The freshwater outlet 1012a is used to collect the condensed, desalinated water. The compartment 1012 includes a dehumidified air outlet 1012b disposed at the top of the second compartment 1012, used to facilitate the recirculation of the dehumidified air 50 back to the sweeping gas chamber 1008. The condenser surface 156 is in connection with the coolant 40, flowing through a coolant chamber 1014. The coolant chamber 1014 includes a coolant inlet 1014a and a coolant outlet 1014b. The water desalination system 1000 uses cold water as a coolant 40 for the desalination process.

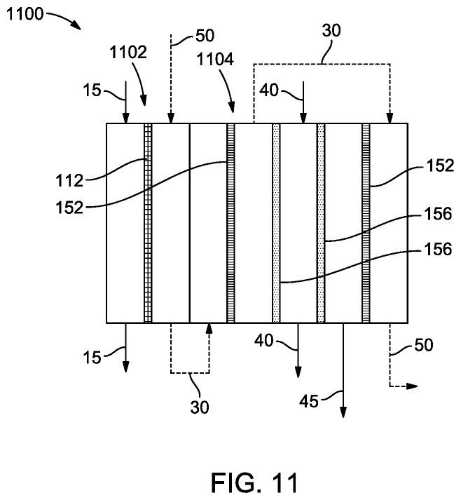

Referring to FIG. 11, a schematic of a water-cooled single-stage, multi-pass water desalination system 1100 is illustrated, according to certain embodiments. The water desalination system 1100 has many similarities to that of the water desalination system 1000 depicted in FIG. 10, such as integrating a SGMD unit 1102 and a JIC unit 1104, combining principles of thermodynamics and fluid dynamics. The water desalination system 1100 includes same key components as of the water desalination system 1000. These components interact, generally, in a similar manner across both systems, leveraging heat exchange and mass transfer processes to achieve the desired desalination outcomes. Further, the integration of the SGMD unit 1102, the JIC unit 1104 and the general flow of the water desalination system 1100 closely resemble those in the water desalination system 1000, and the construction of various elements are not discussed in detail for the brevity in explanation of the water desalination system 1100. However, as illustrated in FIG. 11, the water desalination system 1100 introduces some distinct features in comparison to the water desalination system 1000. These unique features of the water desalination system 1100, which are detailed in the subsequent paragraph(s), cater to specific operational requirements or environmental conditions, thereby extending the versatility and applicability of the water desalination system 1100.

A key feature of the water desalination system 1100, as illustrated in FIG. 11, is the multi-pass configuration of the JIC unit 1104 included in the water desalination system 1100. The multi-pass configuration refers to the inclusion of a plurality of JIC unit 1104 (particularly, two JIC units are shown in FIG. 11) in conjunction with a single SGMD unit 1102 to provide a multi-stage condenser configuration. This multi-pass configuration of the JIC unit 1104 enables a multiple stage system offering the opportunity for progressive and incremental cooling, and condensation, thereby enhancing the overall efficiency and productivity of the condensation process and subsequently of the water desalination system 1100.

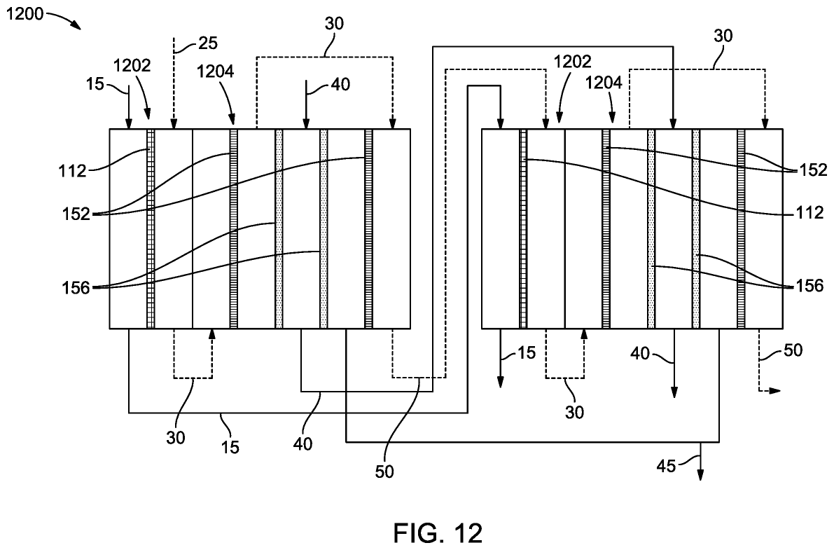

Referring to FIG. 12, a schematic diagram of multi-stage and multi-pass water desalination system 1200, arranged in parallel configuration, is illustrated, according to certain embodiments. The water desalination system 1200 has many similarities to that of the water desalination system 1000 depicted in FIG. 10, such as integrating a plurality of SGMD units 1202 and a plurality of JIC units 1204, combining principles of thermodynamics and fluid dynamics. The water desalination system 1200 includes same key components as of the water desalination system 1000. The construction of various elements are not discussed in detail for the brevity in explanation of the water desalination system 1200. These components interact, generally, in a similar manner across both systems, leveraging heat exchange and mass transfer processes to achieve the desired desalination outcomes. Further, the integration of the SGMD units 1202, the JIC units 1204, and the general flow of the water desalination system 1200 closely resemble those in the water desalination system 1000. However, as illustrated in FIG. 12, the water desalination system 1200 introduces some distinct features in comparison to the water desalination system 1000. These unique features of the water desalination system 1200, which are detailed in the subsequent paragraph(s), cater to specific operational requirements or environmental conditions, thereby extending the versatility and applicability of the water desalination system 1200.

A key feature of the water desalination system 1200, as illustrated in FIG. 12, is the multi-stage configuration of the SGMD unit 1202 in conjunction with the multi-pass configuration of the JIC unit 1204. The multi-stage configuration refers to the inclusion of a plurality of SGMD units 1202 and a plurality of JIC units 1204 in a parallel arrangement with respective to each other to provide a multi-stage distillation and a multi-stage condensation configuration. However, as can be seen in the FIG. 12, a set of SGMD units 1202 and a set of JIC units 1204 are connected to form a multistage configuration. In particular, two JIC units 1204 are connected in series with a single SGMD unit 1202 to form a first stage configuration, as explained in FIG. 11. Further, a second stage configuration is formed by connecting two JIC units 1204 with a single SGMD unit 1202 in series. Both the first stage configuration and the second stage configuration are further connected in parallel to form the multistage water desalination system 1200. In some embodiments, depending upon the output requirements from the water desalination system 1200, the number of the SGMD units 1202 and the JIC units 1204 may be increased as desired to meet the output demand. This multi-stage and multi-pass configuration of the plurality of SGMD units 1202 and the plurality of JIC units 1204 enables a multiple stage system offering the opportunity for progressive and incremental desalination process, cooling, and condensation, thereby enhancing the overall efficiency and productivity of the condensation process and subsequently of the water desalination system 1200.

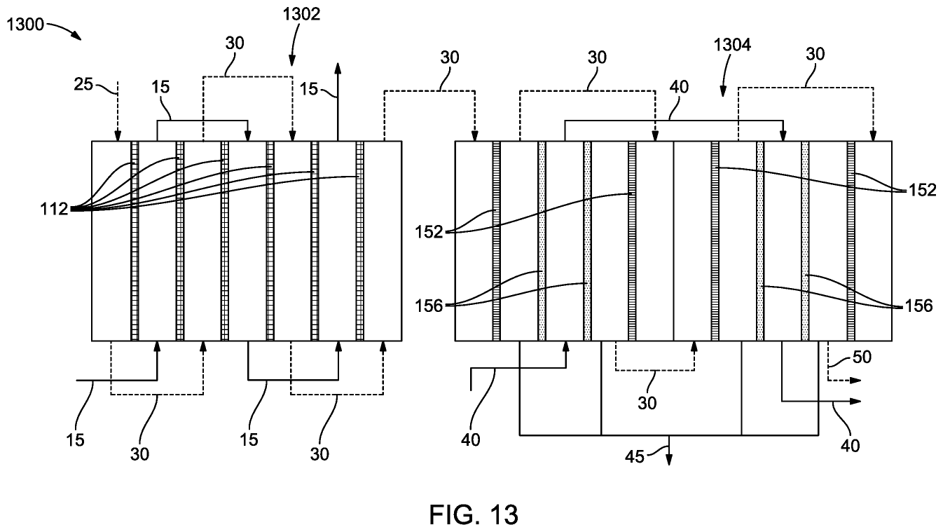

Referring to FIG. 13, a schematic diagram of a multi-stage and multi-pass water desalination system 1300, in series arrangement is illustrated, according to certain embodiments. The water desalination system 1300 has many similarities to that of the water desalination system 1200 depicted in FIG. 12, such as integrating a plurality of SGMD units 1302 and a plurality of JIC units 1304, combining principles of thermodynamics and fluid dynamics. The water desalination system 1300 includes same key components as of the water desalination system 1000. The construction of various elements are not discussed in detail for the brevity in explanation of the water desalination system 1200. These components interact, generally, in a similar manner across both systems, leveraging heat exchange and mass transfer processes to achieve the desired desalination outcomes. Further, the integration of the SGMD unit 1302, the JIC unit 1304, and the general flow of the water desalination system 1300 closely resemble those in the water desalination system 1200. However, as illustrated in FIG. 13, the water desalination system 1300 introduces some distinct features in comparison to the water desalination system 1200. These unique features of the water desalination system 1300, which are detailed in the subsequent paragraph(s), cater to specific operational requirements or environmental conditions, thereby extending the versatility and applicability of the water desalination system 1300.

A key feature of the water desalination system 1300, as illustrated in FIG. 13, is the multi-stage configuration of the SGMD units 1302 in conjunction with the multi-pass configuration of the JIC units 1304. The multi-stage configuration refers to the inclusion of the plurality of SGMD units 1302 and the plurality of JIC units 1304 in a series arrangement with respective to each other to provide a multi-stage distillation and a multi-stage condensation configuration. However, as can be seen in the FIG. 13, a set of SGMD units 1302 in fluid communication with each other and a set of JIC units 1304 in fluid communication with each other, are connected in a series configuration with each other. In some embodiments, depending upon the output requirements from the water desalination system 1300, the number of the SGMD unit 1302 and the JIC unit 1304 may be increased as desired to meet the output demand. This multi-stage and multi-pass configuration of the plurality of SGMD unit s1302 and the plurality of JIC units 1304 enables a multiple stage system offering the opportunity for progressive and incremental desalination process, cooling, and condensation, thereby enhancing the overall efficiency and productivity of the condensation process and subsequently of the water desalination system 1300.

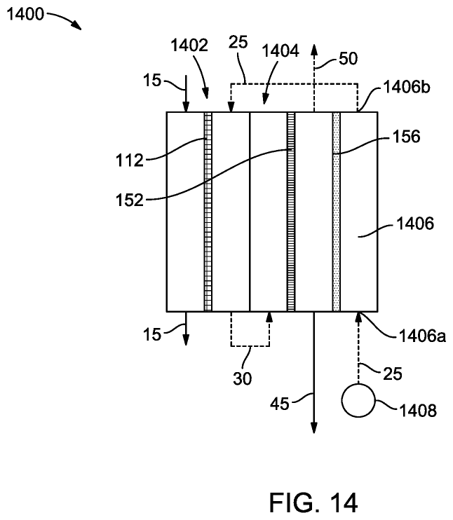

Referring to FIG. 14, a schematic diagram of an air-cooled single-stage and single-pass water desalination system 1400 is illustrated, according to certain embodiments. The water desalination system 1400 has many similarities to that of the water desalination system 1000 depicted in FIG. 10, such as integrating a SGMD unit 1402 and a JIC unit 1404, combining principles of thermodynamics and fluid dynamics. The water desalination system 1400 includes same key components as of the water desalination system 1000. These components interact, generally, in a similar manner across both systems, leveraging heat exchange and mass transfer processes to achieve the desired desalination outcomes. Further, the integration of the SGMD unit 1402, the JIC unit 1404 and the general flow of the water desalination system 1400 closely resemble those in the water desalination system 1000. However, as illustrated in FIG. 14, the water desalination system 1400 introduces some distinct features in comparison to the water desalination system 1000. These unique features of the water desalination system 1400, which are detailed in the subsequent paragraph(s), cater to specific operational requirements or environmental conditions, thereby extending the versatility and applicability of the water desalination system 1400.

A key feature of the water desalination system 1400, as illustrated in FIG. 14, is an air-cooled configuration of the water desalination system 1400, achieved with the inclusion of an air compressor 1408. In particular, dehumidified air 50 is used as the heat transfer medium or coolant for cooling the condenser surface 156 present in the JIC unit 1404. The JIC unit 1404 further includes a coolant chamber 1406, having an air inlet 1406a disposed at the bottom of coolant chamber 1406 and an air outlet 1406b disposed at the top of the coolant chamber 1406. The air inlet 1406a is in fluid communication with the air compressor 1408, generating and providing a pressurized stream of the dehumidified air 50 to the coolant chamber 1406. The coolant chamber 1406 is in connection with the condenser surface 156, the dehumidified air 50 lowers the temperature of the condenser surface 156 below the dew point temperature of the humidified air 30 coming from the SGMD unit 1402. The air outlet 1406b is further connected to the sweeping gas inlet 1010a of the SGMD unit 1402. This air-cooled configuration of the water desalination system 1400 enables for an efficient system offering the opportunity for liquid coolant less cooling system, resulting in the reduction of the preventative maintenance of the cooling system, thereby enhancing the overall efficiency and productivity of the condensation process and subsequently of the water desalination system 1400.

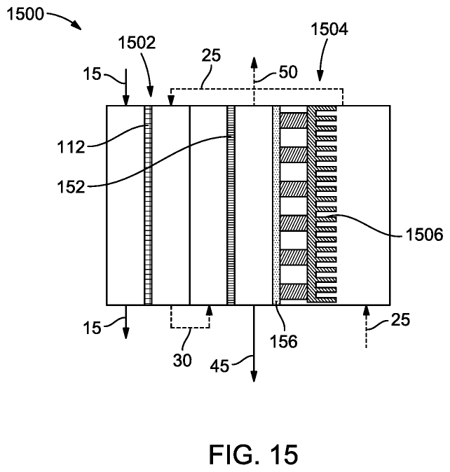

Referring to FIG. 15, a schematic diagram of a thermoelectrically cooled single-stage and single-pass water desalination system 1500 is illustrated, according to certain embodiments. The water desalination system 1500 has many similarities to that of the water desalination system 1000 depicted in FIG. 10, such as integrating a SGMD unit 1502 and a JIC unit 1504, combining principles of thermodynamics and fluid dynamics. The water desalination system 1500 includes same key components as of the water desalination system 1000. These components interact, generally, in a similar manner across both systems, leveraging heat exchange and mass transfer processes to achieve the desired desalination outcomes. Further, the integration of the SGMD unit 1502, the JIC unit 1504 and the general flow of the water desalination system 1500 closely resemble those in the water desalination system 1000. However, as illustrated in FIG. 15, the water desalination system 1500 introduces some distinct features in comparison to the water desalination system 1500. These unique features of the water desalination system 1500, which are detailed in the subsequent paragraph(s), cater to specific operational requirements or environmental conditions, thereby extending the versatility and applicability of the water desalination system 1500.

A key feature of the water desalination system 1500, illustrated in FIG. 15, is the inclusion of a thermoelectric condenser (TEC) 1506. In general, a TEC, may also be referred to as a thermoelectric cooler. The TEC 1506 is an electrical device made of semiconductors, acting as a miniature heat pump, transporting heat between one side of the TEC 1506 to the other side of the TEC 1506. A temperature difference between two ends of the TEC 1506 may also be used to produce electricity. The TEC 1506 is a solid-state energy converter made up of a group of thermocouples connected electrically and thermally in series and parallel, respectively. In particular, a thermocouple is formed by two semiconductors that produce a TEC effect if a voltage is supplied in the right direction to the linked junction. In an embodiment, the TEC 1506 may use both the N-type and the P-type Bismuth Telluride materials. In another embodiment, the TEC 1506 may use any other suitable semiconductor materials. The TEC 1506 is in thermal communication with a condenser surface 156 present in the JIC unit 1504. The cooling effect produced by the TEC 1506 induces cooling in the condenser surface 156. The condenser surface 156 is at a lower temperature than the dew point temperature of the concentrated humidified air 30 coming from the SGMD unit 1502. This thermoelectrically cooled configuration of the water desalination system 1500 has many benefits over traditional cooling methods, such as, small size, lightweight, high dependability, lack of physical moving components, and lack of working fluid, resulting in the reduction of the preventative maintenance of the cooling system, thereby enhancing the overall efficiency and productivity of the condensation process and subsequently of the water desalination system 1500.

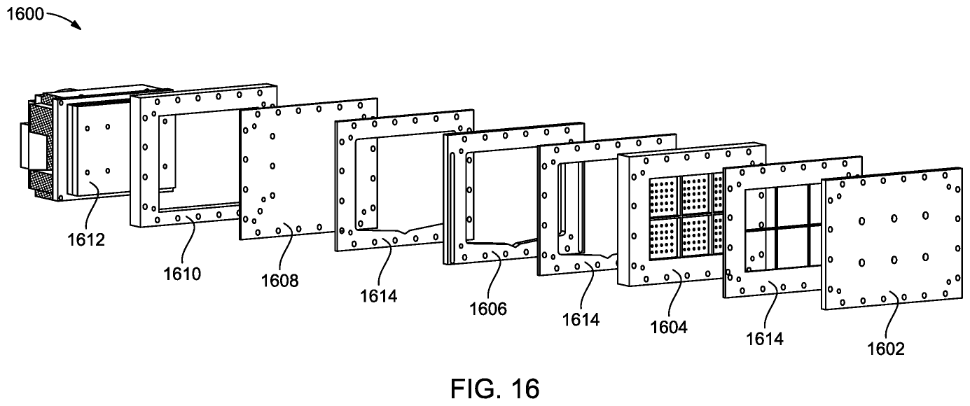

Referring to FIG. 16, an exploded view of a jet impingement thermoelectric condenser (JITEC) 1600 shown in FIG. 15 is illustrated, according to certain embodiments. The JITEC 1600 includes an inlet air plate 1602, a perforated plate 1604, a spacer 1606, a copper plate 1608, a holder 1610, a TEC unit 1612, and a plurality of gaskets 1614. In an embodiment, an area of the JIC unit is in a range of about 300×220 mm² up to 1500×1100 mm², while the effective condensation area in a range of about 0.0277 m² up to 0.15 m². The inlet air plate 1602 has a thickness in a range of about 10 mm up to 50 mm, and the inlet air plate 1602 is symmetric where it has about six to eight inlet holes to let the humid air 30 enter the JIC unit. The perforated plate 1604 has a thickness in a range of about 20 mm up to 150 mm, the perforated plate 1604 includes about multiple accumulation areas, typically four to ten in a range of about 60×60 mm² up to 350×350 mm² with a depth in a range of about 6 mm up to 10 mm each, and 20 up to 30, generally 25 perforations (or circular apertures) with a diameter in a range of about 1 mm up to 4.5 mm for each accumulation area. The distance between one aperture to the other aperture is in a range of about 8 mm up to 30 mm. The spacer 1606 has a thickness in a range of about 10 mm up to 75 mm, and an exit hole at the bottom of a diameter in a range of about 8 mm up to 20 mm to collect the distillate 45 produced by the JIC unit. The copper plate 1608 has a thickness in a range of about 1.2 mm up to 6 mm, while the holder 1610 has a thickness in a range of about 22 mm up to 148 mm. A hollow area in a range of about 216×162 mm² up to 1080×810 mm² is spaced out in the holder 1610 to house the TEC unit 1612 within the JIC unit. Moreover, a small groove is indented on the holder 1610 to let thermocouple sensor to be housed inside the hollow area and connect to the TEC unit 1612. One of the plurality gaskets 1614 is placed between the inlet air plate 1602 and perforated plate 1604, and two gaskets of the plurality of gaskets 1614 sandwich the spacer 1606 from both sides.

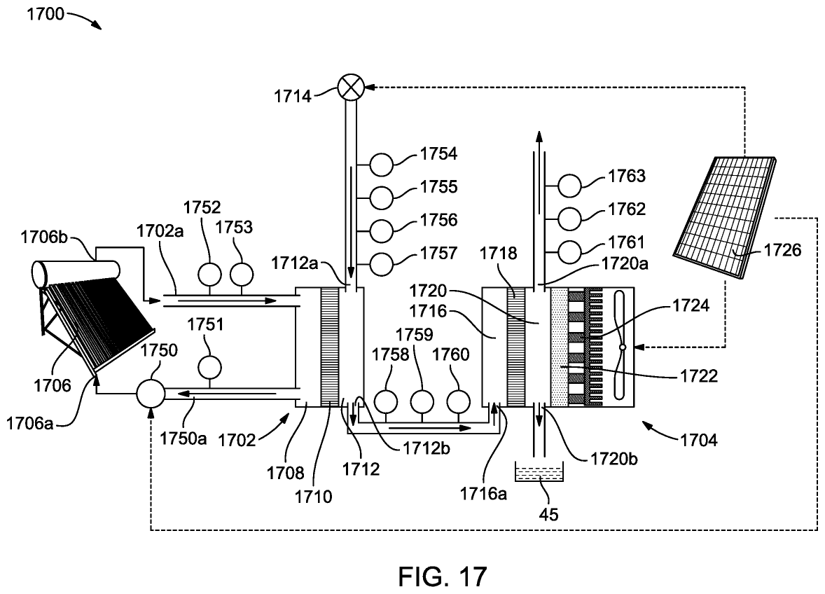

Referring to FIG. 17, a schematic diagram of a solar powered water desalination system 1700 is illustrated, according to certain embodiments. The water desalination system 1700 is further described with reference to the water desalination system 100 explained in FIG. 2. The water desalination system 1700 includes a SGMD unit 1702 and a thermoelectrically cooled JIC unit 1704, otherwise referred to as JITEC unit 1704. Further, the water desalination system 1700 includes a solar water heater 1706 in thermal and fluid communication with the SGMD unit 1702. The solar water heater 1706 includes an inlet 1706a, in fluid communication with a pump 1750. The pump 1750 transfers pressurized water to the solar water heater 1706, and the water is further recirculated from the SGMD unit 1702. An input line 1750a of the pump 1750 includes a first temperature probe 1751. The solar water heater 1706 includes an outlet 1706b, in fluid communication with an inlet 1702a of the SGMD unit 1702. The path from the inlet 1702a to a first compartment 1708 of the SGMD unit 1702 includes a second temperature probe 1752 and a first flow meter 1753. The water desalination system 1700 includes a membrane 1710, disposed between the first compartment 1708 and a sweeping gas chamber 1712, alternatively referred to as the second compartment 1712. The sweeping gas chamber 1712 includes an inlet 1712a disposed at the top of the sweeping gas chamber 1712 and an outlet 1712b disposed at the bottom of the sweeping gas chamber 1712. The inlet 1712a receives pressurized air from an air compressor 1714. The path between the air compressor 1714 and the inlet 1712a includes a plurality of sensors, including a first humidity sensor 1754, a first pressure gauge 1755, a third temperature probe 1756, and a second flow meter 1757. The outlet 1712b is in further fluid communication with an inlet 1716a of an air accumulation enclosure 1716 of the JITEC unit 1704. The path between the outlet 1712b and the inlet 1716a includes a plurality of sensors, including a second humidity sensor 1758, a second pressure gauge 1759 and a fourth temperature probe 1760. The JITEC unit 1704 further includes a perforated plate 1718, a third compartment 1720 and a condenser surface 1722. The third compartment 1720 includes a first outlet 1720a for the dehumidified air 50. The outlet path from the outlet 1720a includes a plurality of sensors, including a fifth temperature probe 1761, a third pressure gauge 1762 and a third humidity sensor 1763. The third compartment 1720 further includes a second outlet 1720b for the distillate 45 alternatively referred to as the desalinated water 45. The third compartment 1720 is in thermal communication with the condenser surface 1722. The condenser surface 1722 is in thermal communication with a thermoelectric condenser 1724. The thermoelectric condenser 1724 is powered by, and in electrical communication with, a photovoltaic panel (PV panel) 1726. The PV panel 1726 also powers the pump 1750 included in the SGMD unit 1702.

The present disclosure further provides experimental data obtained from testing the water desalination system 100 of FIG. 1 (taken as reference) as per embodiments of the present disclosure. The experimental setup was modeled based on the water desalination system 100, which shows the SGMD unit 102 in integration with the JIC unit 104. In addition, key components such as, the heat exchanger 155, the water heater 115, and the air compressor 118 were also included in the experimental setup while devising results from the experimental setup.

In order to evaluate the performance of the water desalination system 100, the temperatures and flow rates at different sections were measured. The condensate volume was tracked with time to obtain information about the heat transfer rate. The heat transfer rate from SGMD unit 102 and JIC unit 104 can be obtained as:

$$Qf = \dot{m} fCp , f Δ Tf \\ Qc = \dot{m} cCp , c Δ Tc$$

Where f and c represent the feed and coolant for each humidifier and dehumidifier respectively, m is the water mass flow rate, Cp is the specific heat, and ΔT is the difference of temperatures between outlet and inlet of the JIC unit 104. Qin is total energy input (kW) and can be expressed as:

$$Qin = Qf + Qc$$

The condensate mass flow rate was obtained by measuring the condensate mass using an electronic scale over a period of 30 minutes for each run of the experimental setup. The condensate mass was linear with time, indicating a steady state operation. The distilled mass flow rate (kg/h) was then obtained using the following relation:

$$\dot{m} d = \frac{Δ md}{Δ t}$$

And the permeate flux (kg/m²h) can be calculated as:

$${\dot{m}}^{″} = \frac{\dot{m} d}{Am}$$

Where Am is the effective membrane area (66 cm²). This section presents the effects that model and operating factors have on the permeate flux of the water desalination system 100. Testing jet speed, jet size, jet-to-surface distance, and jet-to-surface temperature difference are some of the operating variables. In addition, the fluctuation of the STEC (Specific Thermal Energy Consumption) and the GOR (Gained Output Ratio) with the operational parameters is considered when assessing the system's energy efficiency. GOR is a measurement of the desalination process's thermal efficiency, which gauges how efficiently the system's energy input is converted into clean water production. The effectiveness of the water desalination system 100 is shown by the GOR, and can be calculated using the equation below:

$$GOR = \frac{\dot{md} hfg}{Qin}$$

where, hfg is the latent heat of vaporization of water evaluated at feed temperature. An additional indicator of energy use is the STEC (kWh/m³). Depicting, how much thermal energy the SGMD unit needs to distillate one unit of freshwater every hour. Efficiency of the model is improved through lower energy consumption, and can be written as shown:

$$STEC = \frac{Qin}{ρ \dot{m} d} = \frac{Qin}{\dot{Vd}}$$

Where ρ is the density of distilled water evaluated at room temperature, and V^{⋅}d is the volume flow rate of the distilled water.

In some embodiments, for the purpose of obtaining experimental data, the water desalination system 100 includes a vacuum air (VA) configuration and a compressed air (CA) configuration. The VA configuration uses a vacuum pump instead of an air compressor 118, as used in the CA configuration or the water desalination system 100 as described in FIG. 1. The VA configuration is characterized by a higher permeate flux. The higher permeate flux due to VA configuration compared to the CA configuration can be explained by the fact that lowering the pressure in second compartment of the membrane 112 present in the SGMD unit 102 reduces the mass transfer resistance owing to the increase in the vapor pressure difference across the membrane 112. This allows for more vapor to permeate in the VA configuration compared with CA configuration.

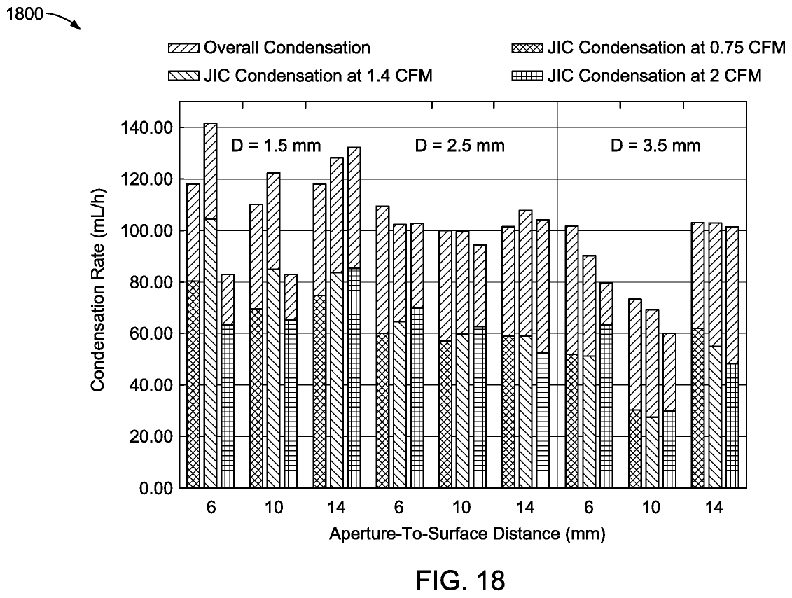

Referring to FIG. 18, a bar graph 1800, depicting the representative data of condensation rate against the aperture-to-surface distance (in mm), is illustrated, according to certain embodiments. The aperture-to-surface distance refers to the distance between the circular apertures (of diameter D) present in the perforated plate of the JIC unit 104 of the water desalination system 100 and the condenser surface present therein. The bar graph 1800, as depicted in FIG. 18, shows the JIC unit condensation values in ml/h (milliliter per hour) at different air flows in CFM (cubic feet per minute), and at different aperture-to-surface distances ranging from 6 mm to 14 mm. As can be seen from the bar graph 1800, the maximum condensation rate (105 ml/h) is achieved when the D is at the lowest (1.5 mm), the aperture-to-surface distance is at the lowest (6 mm) and air flow rate is 1.4 CFM. While the minimum condensation rate (30 ml/h) is achieved when the D is at the highest (3.5 mm), the aperture-to-surface distance is 10 mm and the air flow rate is 1.4 CFM. The bar graph 1800 further shows the overall condensation rate as well, which is the synergically obtained data of the condensation flowrate that occurred at different air flow volume (in CFM). As can be seen from the bar graph 1800, the overall condensation rate is highest at similar conditions as mentioned above.

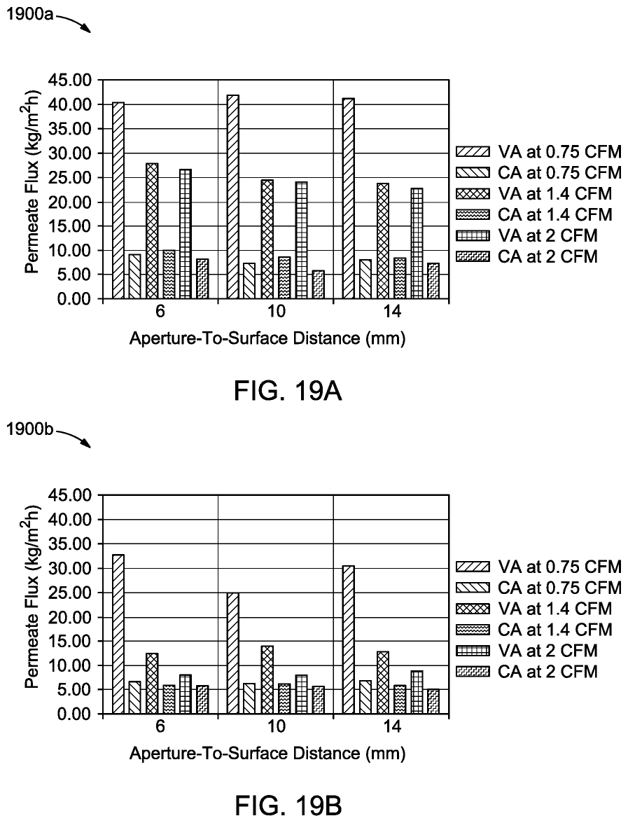

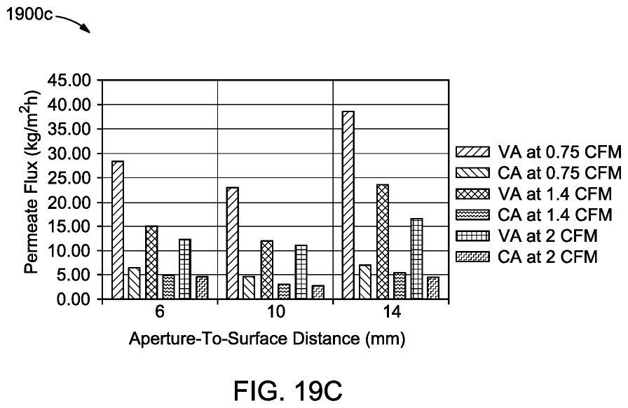

Referring to FIGS. 19A-19C, bar graphs 1900A-1900C are illustrated, according to certain embodiments. The bar graph 1900A is computed at an aperture diameter (D) of 1.5 mm, subsequently bar graphs 1900B and 1900C are computed at a D of 2.5 mm and 3.5 mm, respectively, and the coolant temperature remains constant throughout the experiment at 25° C. The bar graphs 1900A-1900C depicts the total permeate flux (kg/m²h) against the aperture-to-surface distance, ranging from 6 mm to 14 mm for different configurations of the water desalination system 100 (VA and CA configurations). The values are computed and plotted at different air flow rates (in CFM) for the water desalination system 100, ranging from 0.75 CFM to 2.0 CFM. It may be noted from the bar graphs 1900A-1900C, the total permeate flux in the CA configuration of the water desalination system 100, at different values of D, air flow rate, aperture-to-surface distance is far surpassed by the VA configuration.

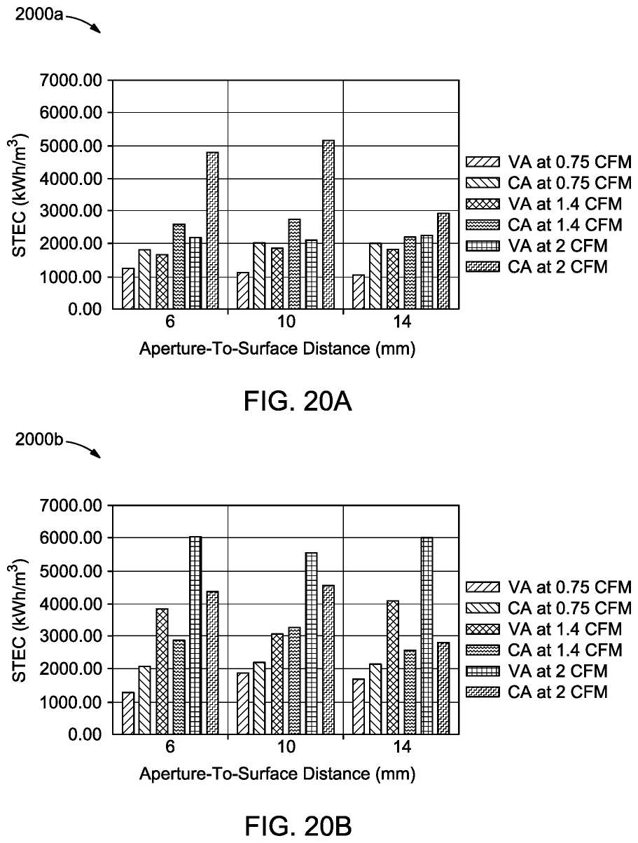

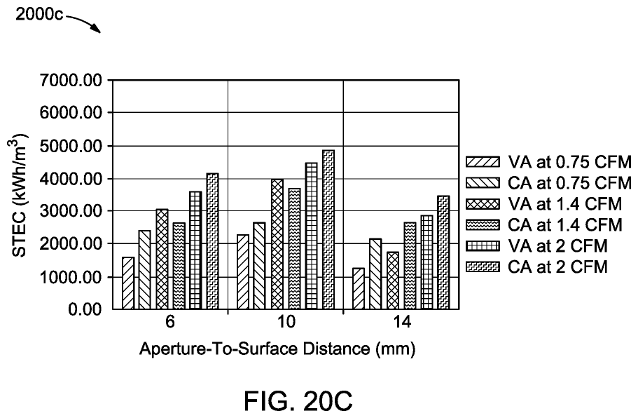

Referring to FIGS. 20A-20C, bar graphs 2000A-2000C are illustrated, according to certain embodiments. The bar graph 2000A is computed at an aperture diameter (D) of 1.5 mm, subsequently bar graphs 2000B and 2000C are computed at a D of 2.5 mm and 3.5 mm, respectively, and the coolant temperature remains constant throughout the experiment at 25° C. The bar graphs 2000A-2000C depicts the specific thermal energy consumption (STEC) in kWh/m³ against the aperture-to-surface distance, ranging from 6 mm to 14 mm for different configurations of the water desalination system 100 (VA and CA configurations). The values are computed and plotted at different air flow rates (in CFM) for the water desalination system 100, ranging from 0.75 CFM to 2.0 CFM. It may be noted from the bar graph 2000A, the STEC of the VA configuration of the water desalination system 100, at different values of D, air flow rate, aperture-to-surface distance is surpassed by the CA configuration. Further, the graph 2000B depicts contrasting results, as the STEC of the CA configuration is higher than the VA configuration at low air flow rates (0.75 CFM). However, the VA configuration surpassed the CA configuration in terms of STEC at higher air flow rates (1.4-2.0 CFM). In an isolated event, in graph 2000B the STEC of the VA configuration is lower than the CA configuration at 10 mm aperture-to-surface distance for 1.4 CFM air flow rate. Furthermore, in the graph 2000C, the STEC of the CA configuration remained higher than the STEC of the VA configuration at 6 mm and 14 mm aperture-to-surface distance for air flow rates of 0.75 CFM and 2 CFM respectively. However, it may be noted from the graph 2000C, the STEC of the VA configuration exceeds the STEC of CA configuration 6 mm and 10 mm of the aperture-to-surface distance for the air flow rate of 1.4 CFM.

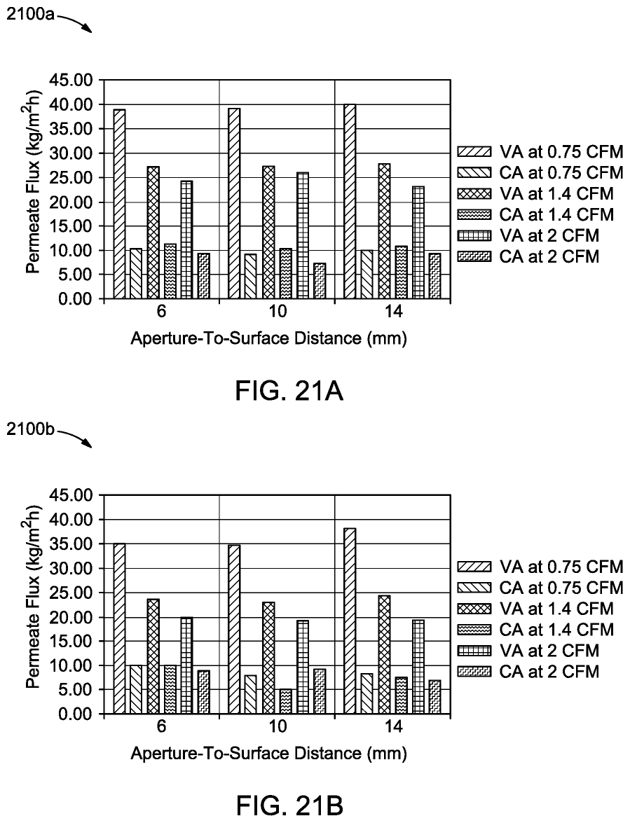

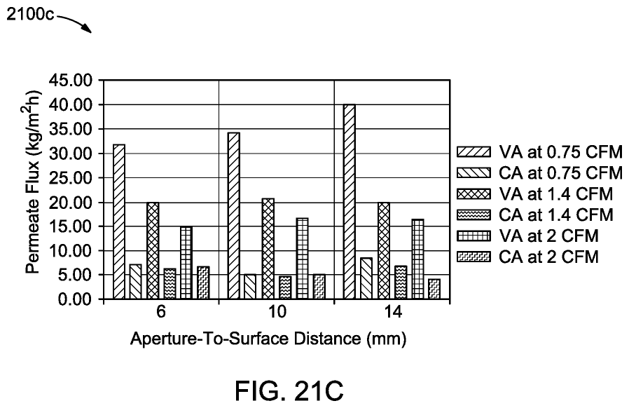

Referring to FIGS. 21A-21C, bar graphs 2100A-2100C are illustrated, according to certain embodiments. The bar graph 2100A is computed at an aperture diameter (D) of 1.5 mm, subsequently bar graphs 2100B and 2100C are computed at a D of 2.5 mm and 3.5 mm, respectively, and the coolant temperature remains constant throughout the experiment at 15° C. The bar graphs 2100A-2100C depict total permeate flux (kg/m²h) against the aperture-to-surface distance, ranging from 6 mm to 14 mm for different configurations of the water desalination system 100 (VA and CA configurations). The values are computed and plotted at different air flow rates (in CFM) for the water desalination system 100, ranging from 0.75 CFM to 2.0 CFM. It is observed that lower the coolant temperature consistently resulted in higher permeate flux, while maintaining the other variables constant. This behavior can be explained by the fact that the permeate flux is proportional to the water vapor concentration difference between the incoming jet of the humidified air from the perforated plate and condenser surface. For a fixed jet temperature and relative humidity, lowering the coolant temperature results in a decrease in the concentration of water vapor at the condenser surface temperature, or a colder surface led to a better condensation. This, in turn, increases the concentration difference between the jet and condensate surface, thereby increasing the driving potential of condensation. As can be seen from the graphs 2100A-2100C, the VA configuration of the system far surpasses the CA configuration in terms of total permeate flux at different aperture-to-surface distance, air flow rate ranging from 0.75 CFM to 2.0 CFM, and at all the three different D.

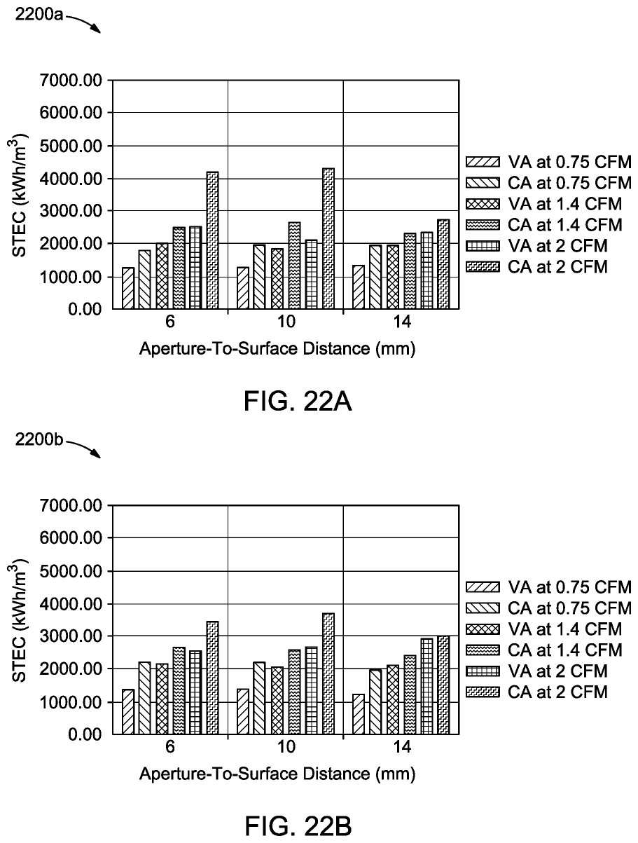

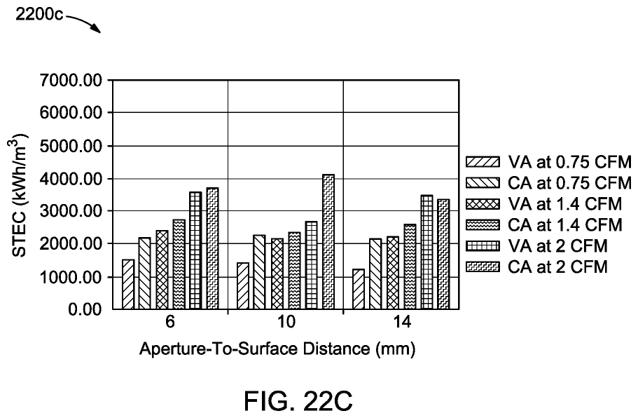

Referring to FIGS. 22A-22C, bar graphs 2200A-2200C are illustrated, according to certain embodiments. The bar graph 2200A is computed at an aperture diameter (D) of 1.5 mm, subsequently bar graphs 2200B and 2200C are computed at a D of 2.5 mm and 3.5 mm, respectively, and the coolant temperature remains constant throughout the experiment at 15° C. The bar graphs 2200A-2200C depicts the specific thermal energy consumption (STEC) in kWh/m³ against the aperture-to-surface distance, ranging from 6 mm to 14 mm for different configurations of the water desalination system 100 (VA and CA configurations). The values are computed and plotted at different air flow rates (in CFM) for the water desalination system 100, ranging from 0.75 CFM to 2.0 CFM. As can be seen from the graphs 2200A-2200C, the VA configuration of the water desalination system 100 is surpassed by the CA configuration in terms of STEC at various aperture-to-surface distances and air flow rates. However, referring to graph 2200C, for aperture diameter 3.5 mm, it may be noted that the VA configuration has slightly more STEC value at 14 mm aperture-to-surface distance and for 2 CFM air flow rate than the CA configuration of the water desalination system 100.

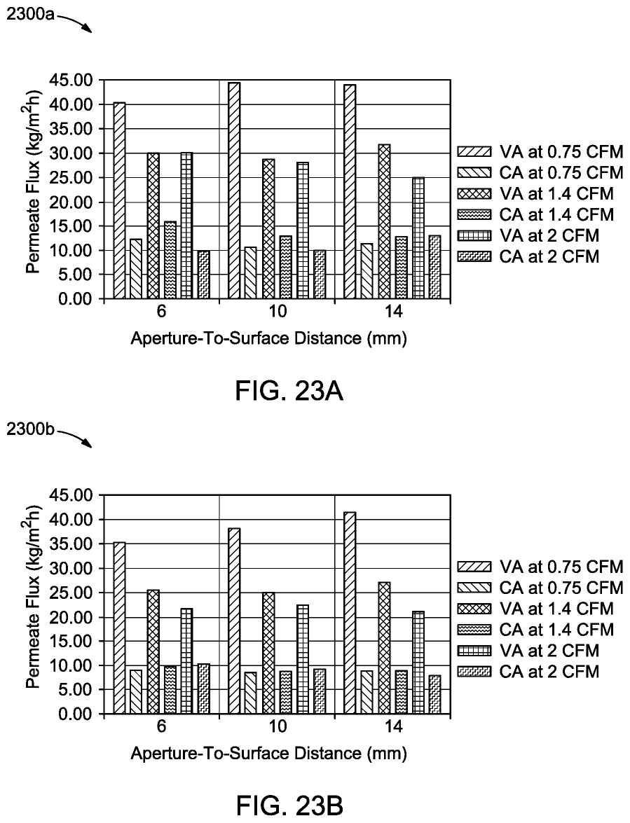

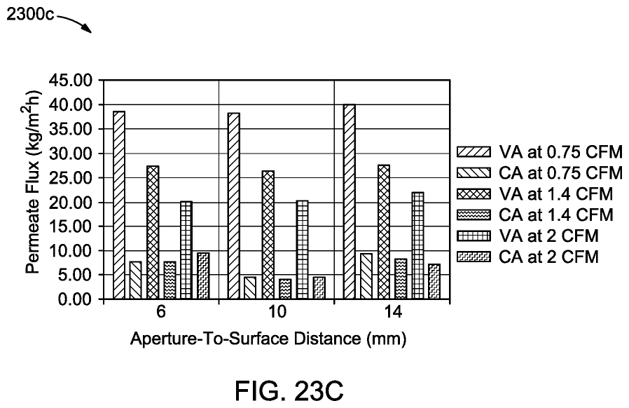

Referring to FIGS. 23A-23C, bar graphs 2300A-2300C are illustrated, according to certain embodiments. The bar graph 2300A is computed at an aperture diameter (D) of 1.5 mm, subsequently bar graphs 2300B and 2300C are computed at a D of 2.5 mm and 3.5 mm, respectively, and the coolant temperature remains constant throughout the experiment at 5° C. The bar graphs 2300A-2300C depicts total permeate flux (kg/m²h) against the aperture-to-surface distance, ranging from 6 mm to 14 mm for different configurations of the water desalination system 100 (VA and CA configurations). The values are computed and plotted at different air flow rates (in CFM) for the water desalination system 100, ranging from 0.75 CFM to 2.0 CFM. It is observed that lower the coolant temperature consistently resulted in higher permeate flux, while maintaining the other variables constant. This behavior can be explained by the fact that the permeate flux is proportional to the water vapor concentration difference between the incoming jet of the humidified air from the perforated plate and condenser surface. For a fixed jet temperature and relative humidity, lowering the coolant temperature results in a decrease in the concentration of water vapor at the condenser surface temperature, or a colder surface led to a better condensation. This, in turn, increases the concentration difference between the jet and condensate surface, thereby increasing the driving potential of condensation. As can be seen from the graphs 2300A-2300C, the CA configuration of the water desalination system 100 is far surpassed, in terms of permeate flux generated, by the VA configuration, at different aperture-to-surface distances, different aur flow rates and a varying and increasing value of the D.

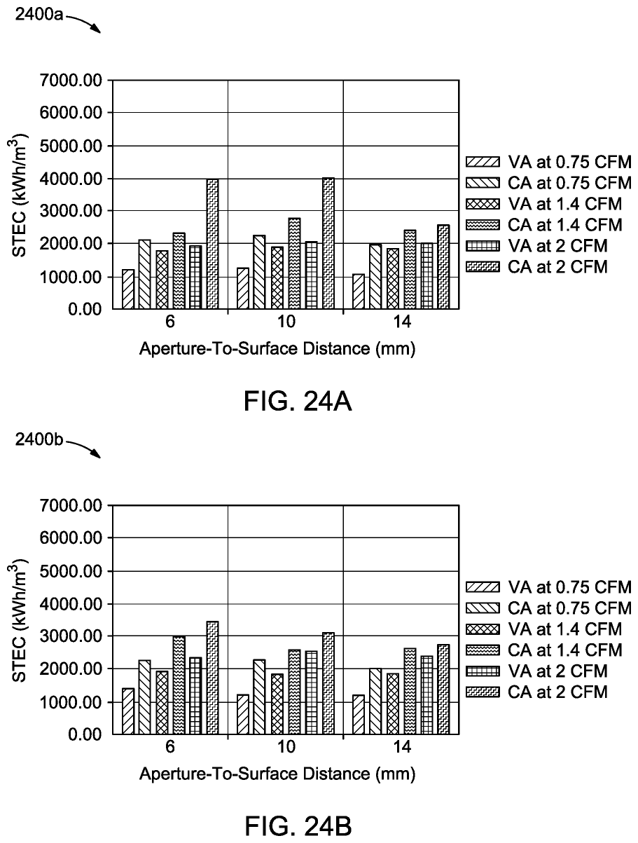

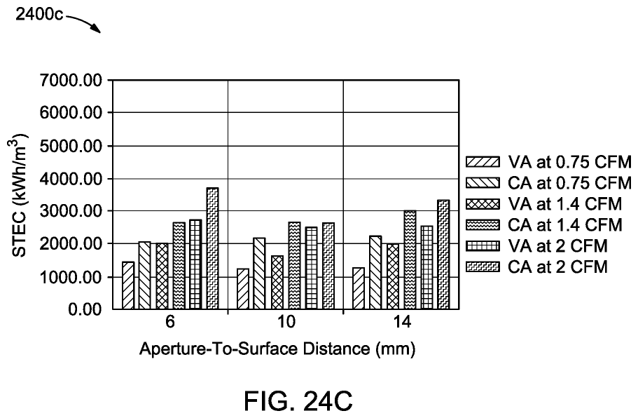

Referring to FIGS. 24A-24C, bar graphs 2400A-2400C are illustrated, according to certain embodiments. The bar graph 2400A is computed at an aperture diameter (D) of 1.5 mm, subsequently bar graphs 2400B and 2400C are computed at a D of 2.5 mm and 3.5 mm, respectively, and the coolant temperature remains constant throughout the experiment at 5° C. The bar graphs 2400A-2400C depicts the specific thermal energy consumption (STEC) in kWh/m³ against the aperture-to-surface distance, ranging from 6 mm to 14 mm for different configurations of the water desalination system 100 (VA and CA configurations). The values are computed and plotted at different air flow rates (in CFM) for the water desalination system 100, ranging from 0.75 CFM to 2.0 CFM. As can be seen from the graphs 2400A-2400C, the VA configuration of the water desalination system 100 is surpassed by the CA configuration in terms of STEC at various aperture-to-surface distances and air flow rates.

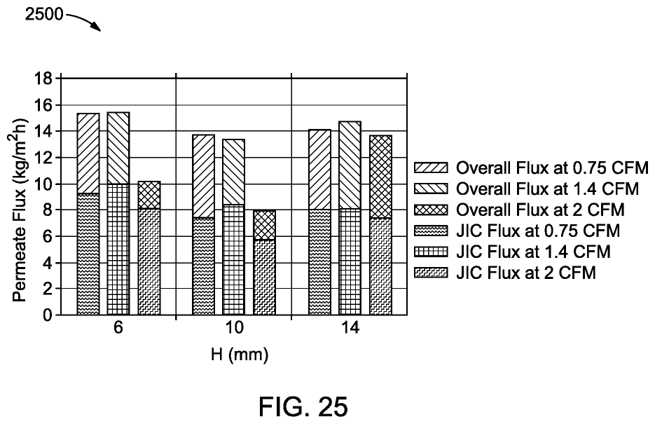

Referring to FIG. 25, a bar graph 2500 is illustrated, depicting the overall permeate flux (in kg/m²h) of the SGMD unit and JIC unit of water desalination system 100 combined, according to certain embodiments. The water desalination system 100 ideally generates condensate at the JIC unit, however, in practicality, the channel walls of the SGMD unit are not perfectly insulated, hence a part of the water vapor condenses in the SGMD unit. The graph 2500 illustrates the overall permeate flux of JIC unit and on top of that, the permeate flux of the SGMD unit combined, at 25° C. coolant temperature, air flow rates of 0.75 CFM to 2.0 CFM, and aperture-to-surface distances of 6 mm to 14 mm. As shown in FIG. 25, increasing the air flow rate decreased the condensation inside the SGMD unit. This translated to a higher residence time associated with low air flow rates in the SGMD unit has a contradictory effect on increasing the evaporation and heat transfer rates, resulting in an increase in the condensation rate in the SGMD unit. This, in turn, lowers the water vapor concentration in the air exiting the SGMD to be further condensed in the JIC unit. In addition, it is interesting to note that, in general, the higher the aperture-to-surface distance, the higher the condensation rate that takes place in the SGMD unit.

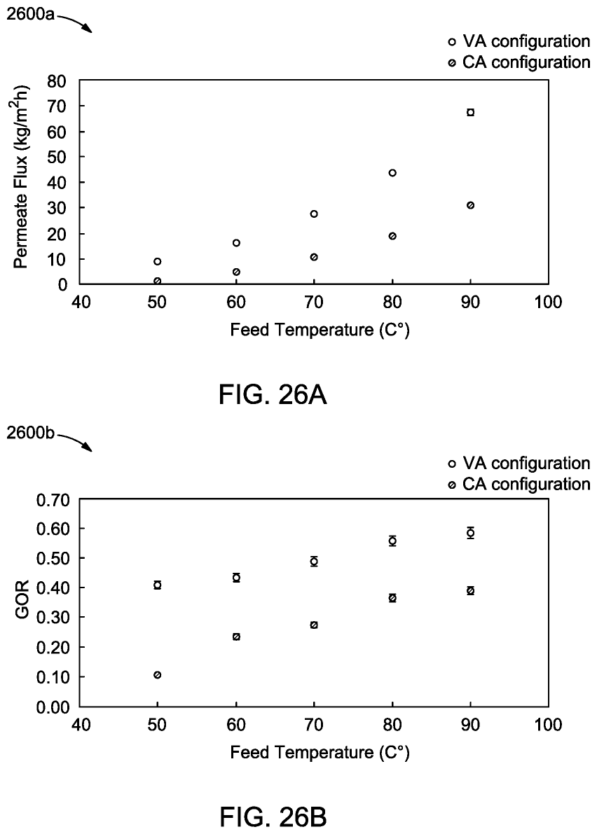

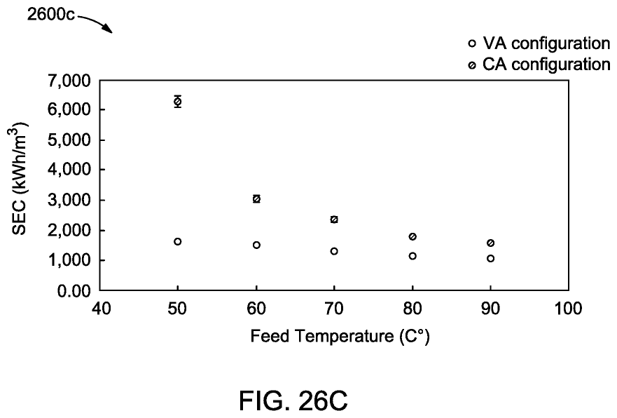

Referring to FIGS. 26A-26C, graphs 2600A-2600C are illustrated, according to certain embodiments. The graphs 2600A-2600C depict the experimentally computed data for the SGMD unit, under the varying conditions of the feed temperature ranging from 50° C. to 90° C., with an increment of 10° C. at each step as shown in FIG. 26A-26C. In addition, the rest of the key parameters were kept constant for the experiment, such as, the coolant temperature at 15° C., the feed flow rate at 4 LPM, the coolant flow rate at 2.3 LPM, the\air flow rate at 0.75 CFM, the aperture diameter at 1.5 mm, and the aperture-to-surface distance at 8 mm. The graph 2600A shows the output permeate flux responds to a change in the feed temperature. It is clear from the graph 2600A that the permeate flux increases substantially with the increase in feed temperature, and that is in turn due to the exponential nature of the relationship between vapor pressure and feed temperature. As can be seen from the graph 2600A, an average increase in permeate flux of 150% and 65% between each set point temperature change, while operating the CA and VA configurations, respectively. The permeate flux is increased by 120% when the VA configuration is used in place of the CA configuration. This enhancement occurred as a result of the vacuum pump's ability to generate a low pressure on the other side of the membrane cell in the sweeping gas chamber. The graph 2600B shows the relation between the GOR and the feed water temperature. The graph 2600B demonstrates that when the feed temperature rises from 50 to 90° C., the GOR improves by 42% for the VA configuration and by 255% for the CA configuration. The graph 2600C shows the relation between the SEC (Specific Energy Consumption) of the SGMD unit of the water desalination system 100, against the effect of increasing feed water temperature. The VA configuration consumes less energy per pure water unit generated, than the CA configuration due to high production of the VA configuration. The SEC reduces with increasing feed temperature, with the lowest values obtained being around 1021 kWh/m³ for the VA configuration system and 1441 kWh/m³ for the CA configuration system.

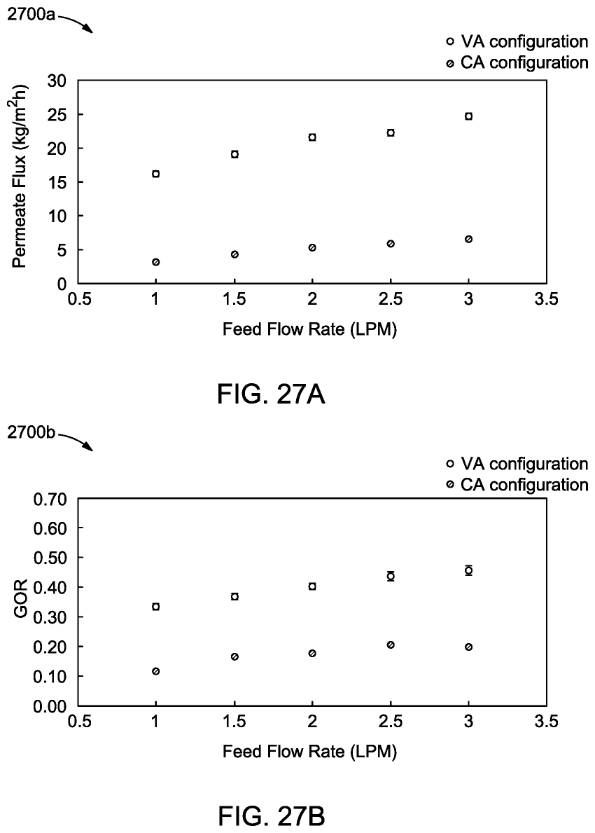

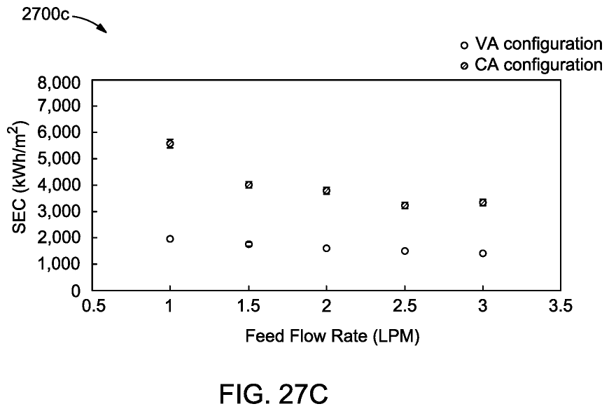

Referring to FIGS. 27A-27C, graphs 2700A-2700C are illustrated, according to certain embodiments. The graphs 2700A-2700C depict the experimentally computed data for the SGMD unit, under the varying conditions of the feed flow rate ranging from 1 LPM to 3 LPM, with an increment of 0.5 LPM at each step as shown in FIG. 27A-27C. In addition, the rest of the key parameters were kept constant for the experiment, such as, the feed temperature at 70° C., the coolant temperature at 15° C., the coolant flow rate at 2.3 LPM, the air flow rate at 0.75 CFM, the aperture diameter at 1.5 mm, and the aperture-to-surface distance at 8 mm. The graph 2700A shows the permeate flux with respect to the change in the feed flow rate. As can be seen from the graph 2700A, the permeate flux increases by 53% with a VA configuration and by 109% with CA configuration when the feed flow rate is raised from 1 LPM to 3 LPM, respectively. In an example, when VA configuration is used instead of the CA configuration, there was a noticeable increase of 274% in terms of the permeate flux. In addition, at a feed flow rate of 3 LPM, the optimum permeate flux readings of 24.91 kg/m²h and 7.18 kg/m²h are recorded utilizing the VA configuration and the CA configuration, respectively. The graph 2700B shows the GOR with respect to the change in the feed flow rate. As can be seen from the graph 2700B, the GOR increased by 33% with the VA configuration and 75% with CA configuration, while the feed flow rate increased from 1 LPM to 2.5 LPM. Following that, the GOR improves for the VA configuration by 5% while decreasing by 5% for the CA configuration, at a feed flow rate of 3 LPM. Collectively, the GOR improved by 135% for the VA configuration. Referring to graph 2700C, there are only slight variations in the STEC with feed flow rate. The graph 2700C shows the SEC with respect to the change in the feed flow rate. As can be seen from the graph 2700C, the SEC reached at the lowest levels when subjected to feed flow rates greater than 3 LPM. The SEC value for the water desalination system 100 system with the VA configuration is 1420 kWh/m³, whereas the with CA configuration is 3341 kWh/m³.

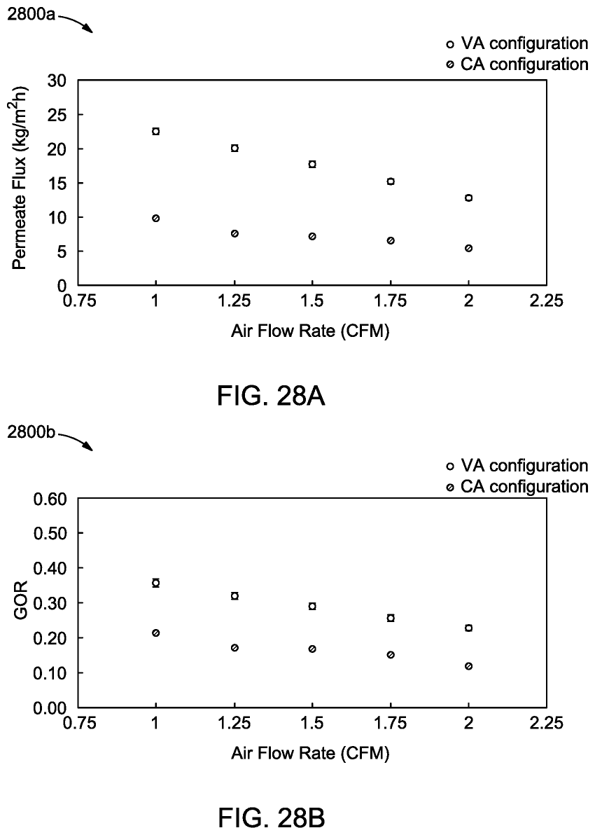

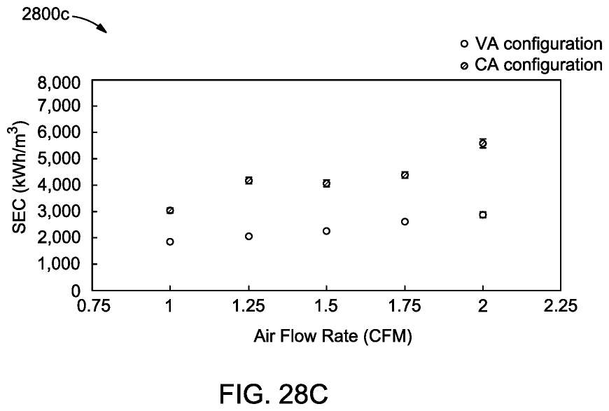

Referring to FIGS. 28A-28C, graphs 2800A-2800C are illustrated, according to certain embodiments. The graphs 2800A-2800C depict the experimentally computed data for the SGMD unit, under the varying conditions of the air flow rate ranging from 1 CFM to 2.27 CFM, with an increment of 0.25 CFM at each step as shown in FIGS. 28A-28C. In addition, the rest of the key parameters were kept constant for the experiment, such as, the feed temperature at 70° C., the coolant temperature at 15° C., the coolant flow rate at 2.3 LPM, the feed flow rate at 4 LPM, the aperture diameter at 1.5 mm, and the aperture-to-surface distance at 8 mm. As can be seen from the graphs 2800A-2800C, when the air flow rate is reduced, the permeate flux increases. This is true for both the VA and CA configurations of the water desalination system 100. Understandably, the longer the air stays in the water desalination system, that is, in either the SGMD or the JIC unit, the higher the production rates. The results can be attributed to the fact that there is less air movement through the SGMD unit, hence, the air stays in the SGMD unit for a longer period of time, causing the air temperature to rise as it passes over the membrane surface. The raised temperature of the air improves its capacity to transport water vapor. This is validated by monitoring the air temperature at the SGMD unit's outlet at various air flow rates. The graph 2800A shows the permeate flux with respect to the change in the air flow rate. In an example, a decrease in the air flowrate from 2 CFM to 1 CFM results in a 76% and an 80% enhancement in permeate flux of the system for the VA configuration and the CA configuration, respectively. The graph 2800B shows the GOR with respect to the change in the air flow rate. As can be seen from the graph 2800B, the GOR increases as the air flow rate is decreased. The GOR of the water desalination system 100 with the VA configuration had a better and efficient ability to decrease the air flow rate in contrast to the system with the CA configuration. In an example, at an air flow rate of 1 CFM, an optimum value of GOR of 0.39 is obtained, this depicts a 57% increase in the GOR when the air flow is reduced from 2 CFM to 1 CFM. The graph 2800C shows the SEC with respect to the change in the air flow rate. As can be seen from the graph 2800C, the effect of increasing the air flow rate shows contrary results for the SEC in respect of the graphs 2800A and 2800B. The SEC increased as the air flow rates are increased in the water desalination system 100.

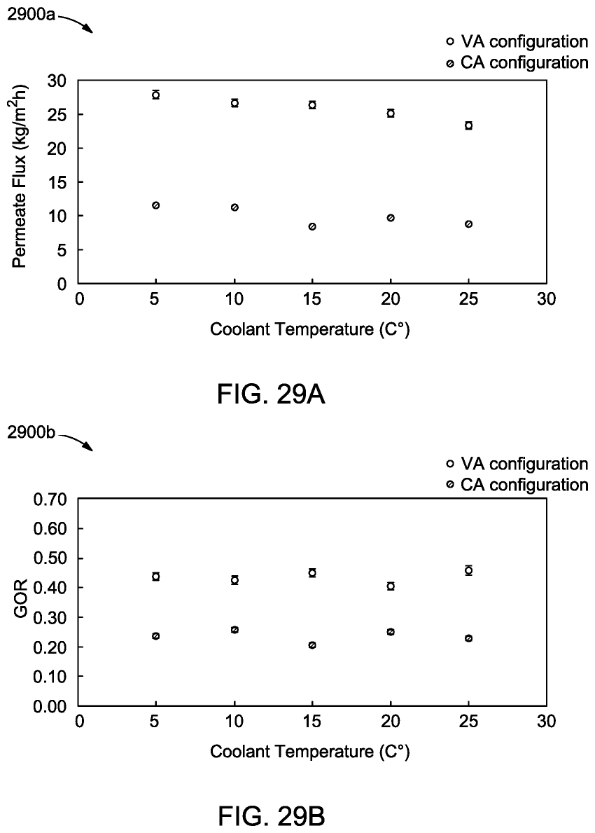

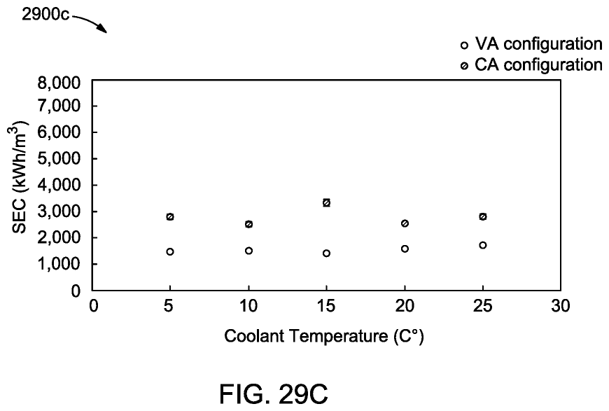

Referring to FIGS. 29A-29C, graphs 2900A-2900C are illustrated, according to certain embodiments. The graphs 2900A-2900C depict the experimentally computed data for the JIC unit, under the varying conditions of the coolant temperature ranging from 5° C. to 25° C., with an increment of 5° C. at each step as shown in FIG. 29A-29C. In addition, the rest of the key parameters were kept constant for the experiment, such as, the feed temperature at 70° C., the air flow rate at 0.75 CFM, the coolant flow rate at 2.3 LPM, the feed flow rate at 4 LPM, the aperture diameter at 1.5 mm, and the aperture-to-surface distance at 8 mm. The graph 2900A shows the permeate flux with respect to the change in the coolant temperature. As can be seen from the graph 2900A, the permeate flux increases with the decrease in the coolant temperature. A 20% increase in permeate flux is noted when the coolant temperature is decreased from 25° C. to 5° C. for the VA configuration, and a 31% increase for the CA configuration. At a coolant temperature of 5° C., the VA configuration produced a peak permeate flux of 28.91 kg/m²h, whereas the Ca configuration produced a peak permeate flux of 12.14 kg/m²h. The graph 2900B shows the GOR with respect to the change in the coolant temperature. As can be seen from the graph 2900B, the GOR remains nearly similar for both the CA and VA configuration individually throughout the coolant temperature change of 5° C. to 25° C. However, it is to be noted that the VA configuration consistently maintained a higher GOR as compared to the GOR of the CA configuration throughout the coolant temperature change of 5° C. to 25° C. The graph 2900C shows the SEC with respect to the change in the coolant temperature. As can be seen from the 2900C, the water desalination system 100 with the VA configuration has a SEC value of a 1392 kWh/m³, whereas the water desalination system 100 with the CA configuration has a SEC value of 2175 kWh/m³. The use of the VA configuration results in an improvement of 36% as compared to the CA configuration.

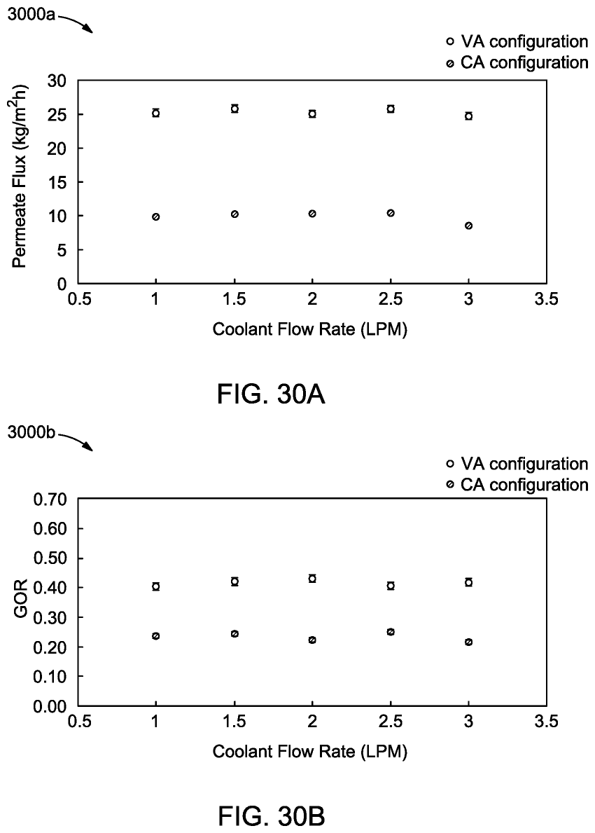

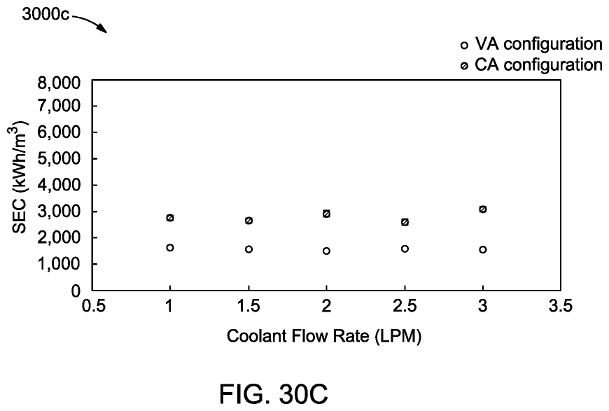

Referring to FIGS. 30A-30C, graphs 3000A-3000C are illustrated, according to certain embodiments. The graphs 3000A-3000C depict the experimentally computed data for the JIC unit, under the varying conditions of the coolant flow rate ranging from 1 LPM to 3 LPM, with an increment of 0.5 LPM at each step as shown in FIG. 30A-30C. In addition, the rest of the key parameters were kept constant for the experiment, such as, the feed temperature at 70° C., the air flow rate at 0.75 CFM, the coolant temperature at 15° C., the feed flow rate at 4 LPM, the aperture diameter at 1.5 mm, and the aperture-to-surface distance at 8 mm. The graph 3000A shows the permeate flux with respect to the change in the coolant flow rate. As can be seen from the graph 3000A, the permeate flux values remains almost similar with respect to the change in the coolant flow rate from 1 LPM to 3 LPM, for both the VA and the CA configuration, individually. However, as shown in the graph 3000A, the VA configuration produced better permeate flux results consistently when compared to the CA configuration. The graph 3000B shows the GOR with respect to the change in the coolant flow rate. As can be seen from the graph 3000B, the GOR remains almost similar at 0.40 for the VA configuration and 0.20 for the CA configuration. In fact, the trend of GOR is similar to the trend of permeate flux in respect to the change in the coolant flow rate. The graph 3000C shows the SEC with respect to the change in the coolant flow rate. As can be seen from the graph 3000C, the SEC remained almost similar at around 3000 kWh/m³ for the CA configuration and at around 1500 kWh/m³ for the VA configuration.

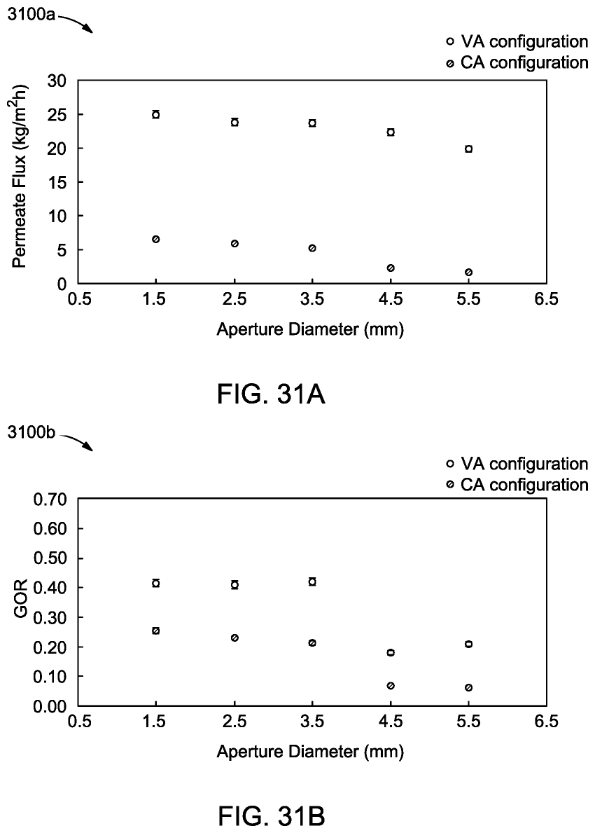

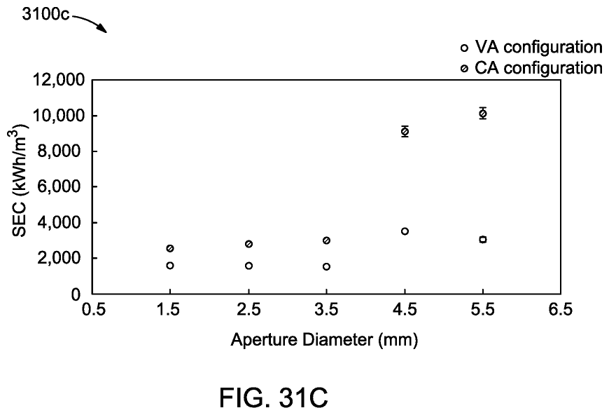

Referring to FIGS. 31A-31C, graphs 3100A-3100C are illustrated, according to certain embodiments. The graphs 3100A-3100C depict the experimentally computed data for the JIC unit, under the varying aperture diameter (D) ranging from 1.5 mm to 5.5 mm, with an increment of 1.0 mm at each step as shown in FIG. 31A-31C. In an example, the perforated plate employed for this experiment includes 25 equidistant holes. In addition, the rest of the key parameters were kept constant for the experiment, such as, the feed temperature at 70° C., the air flow rate at 0.75 CFM, the coolant temperature at 15° C., the feed flow rate at 4 LPM, the coolant flow rate at 2.3 LPM, and the aperture-to-surface distance at 8 mm. The graph 3100A shows the permeate flux with respect to the increase in the aperture diameter (D). As can be seen from the graph 3100A, with a decrease in the D, there is an increase in the permeate flux. This is caused due to the increase in jet speed as the D decreases. In an example, decreasing the aperture diameter from 5.5 mm to 1.5 mm results in a 26% increase in the permeate flux for the VA configuration and a 300% increase in permeate flux for the CA configuration, accordingly. The graph 3100B shows the GOR with respect to the increase in the D. As can be seen from the graph 3100B, the GOR value increases as the D increases. In an example, the CA configuration achieved a GOR of 0.25 with the D being 1.5 mm and the VA system achieved a GOR of 0.45 at the same D. The graph 3100C shows the SEC with respect to the increase in the D. As can be seen from the graph 3100C, the SEC decreased with the decrease in the D values from 5.5 mm to 1.5 mm. In an example, the CA configuration achieved a SEC value of 2576 kWh/m³ at a D of 1.5 mm and the VA configuration achieved a SEC value of 1570 kWh/m³ at a D of 1.5.

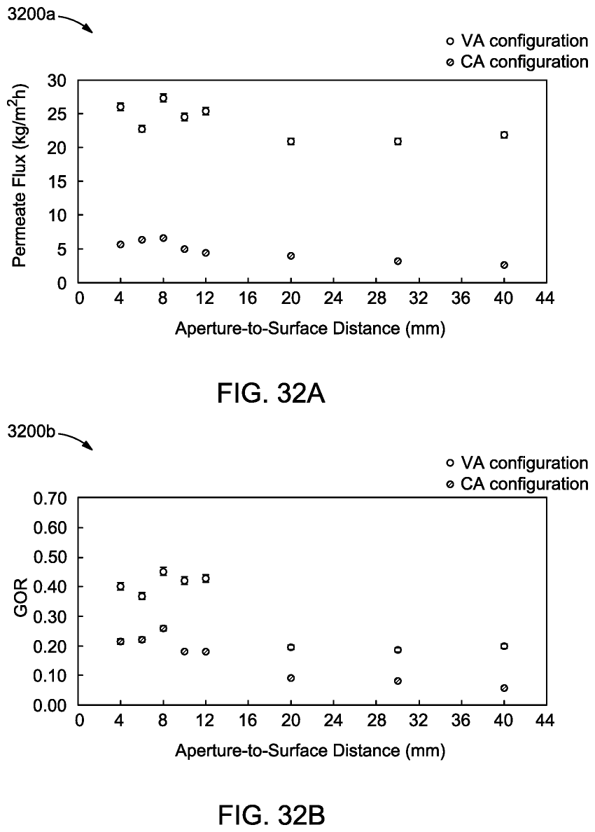

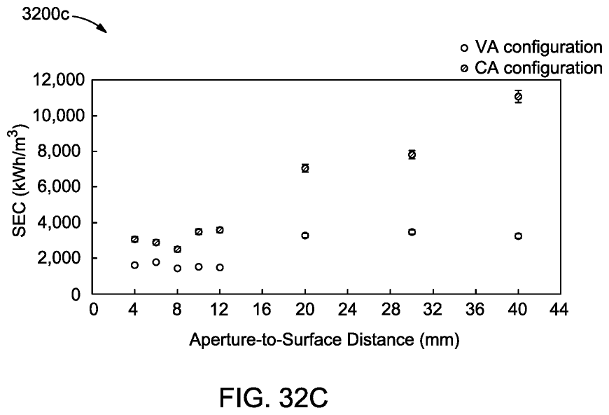

Referring to FIGS. 32A-32C, graphs 3200A-3200C are illustrated, according to certain embodiments. The graphs 3200A-3200C depict the experimentally computed data for the JIC unit, under the varying aperture-to-surface distance ranging from 4 mm to 40 mm, with an increment of 4 mm, 6 mm, 8 mm, 10 mm, 12 mm, 20 mm, 30 mm to 40 mm, as shown in FIG. 32A-32C. In an example, the perforated plate employed for this experiment includes 25 equidistant holes. In addition, the rest of the key parameters were kept constant for the experiment, such as, the feed temperature at 70° C., the air flow rate at 0.75 CFM, the coolant temperature at 15° C., the feed flow rate at 4 LPM, the coolant flow rate at 2.3 LPM, and the aperture diameter at 1.5 mm. The graph 3200A shows the permeate flux with the variation in the aperture-to-surface distance. As can be seen from the graph 3200A, the variation in the permeate flux is unpredictable with the variation in the aperture-to-surface distance for both the CA and the VA configuration. This unpredictability can be justified by the fact that the heat and mass transfer rates do not vary monotonically with aperture-to-surface distance. The graph 3200B shows the GOR with respect to the variation in the aperture-to-surface distance. As can be seen from the graph 3200B, the variation in the GOR values is again unpredictable for both the CA and the VA configuration and for the similar reasons as from FIG. 32B. The graph 3200C shows the SEC with respect to the change in the aperture-to-surface distance. As can be seen from the graph 3200C, the variation in the SEC values is yet again unpredictable for both the CA and the VA configurations. However, it can be computed and understood from the FIGS. 32A-32C, that the lower is the aperture-to-surface distance, the higher is the permeate flux and GOR of the system, indicating that the efficiency of the water desalination system for both the CA and the VA configuration is greater when the aperture-to-surface distance is lower. This fact is concretely supported by the SEC values as shown in the graph 3200C of FIG. 32C, where the SEC is lower for the lower values of the aperture-to-surface distance, for both the CA and the VA configurations, again solidifying the fac that the low aperture-to-surface distance improves the efficiency of the water desalination system 100.

The water desalination system 100, with its different configurations, proposed in the present disclosure may find wide-ranging applications across various industries, as well as in specific processes requiring water treatment and temperature regulation. The system may be employed to desalinate seawater, thereby producing freshwater for various uses, including drinking, irrigation, and industrial processes. The system may be used for the purification of water used in textile manufacturing processes, aiding in the removal of dyes and other contaminants. The system may play a crucial role in the purification of water used in chemical synthesis and pharmaceutical production, helping maintain the purity of the products and adhere to stringent regulations. In the food industry, the system may be used in processes such as milk processing and fruit juice concentration, by aiding in the removal of impurities, ensuring the safety and quality of the products. The system may be used in biomedical applications such as the removal of pure water from blood and protein solutions, supporting research and development in the healthcare sector. The system may also be utilized in the separation of azeotropic aqueous mixtures, such as the separation of alcohol and water mixtures, enhancing the efficiency of industrial processes. The system may find applications in brine mining and in processes that require zero liquid discharge, contributing to resource conservation and environmental protection. The system may also be deployed in applications where high-temperature processing causes thermal degradation of the process flow, providing a solution that balances temperature regulation and efficient operation. More generally, the system may be used for the treatment of wastewater, reducing environmental impact, and aiding in sustainability efforts.

Numerous modifications and variations of the present disclosure are possible in light of the above teachings. It is therefore to be understood that within the scope of the appended claims, the invention may be practiced otherwise than as specifically described herein.

1. A water desalination system, comprising:
a sweeping gas membrane distillation unit, comprising:
a sweeping gas enclosure, comprising
a first compartment comprising a water inlet pipe and a water outlet pipe;
a second compartment comprising an air inlet and a humidified air outlet; and
a membrane disposed in the sweeping gas enclosure, wherein the membrane separates the first compartment and the second compartment;
a water heater connected between a distal end of the water inlet pipe and a distal end of the water outlet pipe, wherein the water heater is in fluid communication with the first compartment and the membrane; and
an air compressor having an air compressor outlet connected to the air inlet of the second compartment, wherein the air compressor is in fluid communication with the membrane;
a jet impingement condenser unit, comprising:
a condenser enclosure, comprising:
an air accumulation compartment with an air accumulation inlet connected to the humidified air outlet of the sweeping gas membrane distillation unit;
a perforated plate disposed in the condenser enclosure having a plurality of perforations, wherein the perforated plate is in contact with the air accumulation compartment;
a condenser surface disposed in the condenser enclosure proximal to the perforated plate; and
a third compartment between perforated plate and the condenser surface; comprising a gas outlet and a water outlet;
a coolant compartment with a coolant inlet pipe and a coolant outlet pipe, wherein the condenser surface is a wall of the coolant compartment; and
a chiller connected between a distal end of the coolant inlet pipe and a distal end of the coolant outlet pipe, wherein the coolant compartment is in fluid communication with the chiller; and
a connector comprising an elongated cylindrical pipe and a secondary cylindrical pipe integrated with a vacuum pump connected in parallel, wherein the connector extends from the humidified air outlet of the sweeping gas membrane distillation unit to the air accumulation inlet of the jet impingement condenser unit, wherein the connector is configured to pass the humidified air from the sweeping gas membrane distillation unit to the jet impingement condenser unit.

2. The water desalination system of claim 1, wherein a controller unit comprising a water pump, one or more thermocouples, one or more flow meter, a pressure gauge, a humidity sensor, and a power sub-unit is coupled to the sweeping gas membrane distillation unit, the jet impingement condenser unit, and the connector.

3. The water desalination system of claim 1, wherein the plurality of perforations of the perforated plate are at least one of circular apertures, cylindrical apertures, and conical apertures.

4. The water desalination system of claim 1, wherein a block having a depression forming the third compartment of the jet impingement condenser unit when mated with the perforated plate.

5. The water desalination system of claim 1, wherein the condenser surface has an array of conical projections having a height of up to 5 mm extending from respective conical bases of the array of conical projections.

6. The water desalination system of claim 1, wherein the membrane is a hydrophobic material.

7. The water desalination system of claim 1, wherein the membrane of the sweeping gas membrane distillation unit is coupled to a membrane-support plate having a plurality of micropores.

8. The water desalination system of claim 1, wherein the sweeping gas membrane distillation unit comprises at least one of a cylindrical configuration and a flat plate configuration.

9. The water desalination system of claim 1, wherein the jet impingement condenser unit comprises at least one of a cylindrical configuration and a flat plate configuration.

10. The water desalination system of claim 1, comprising a plurality of the sweeping gas membrane distillation enclosures connected in at least one of a series configuration, a parallel configuration, and a series-parallel configuration to provide a multistage distillation configuration.

11. The water desalination system of claim 1, comprising a plurality of the condenser enclosures connected in at least one of a series configuration, a parallel configuration, and a series-parallel configuration separated by a plurality of coolant compartments to provide a multistage condenser configuration.

12. The water desalination system of claim 1, comprising a plurality of the sweeping gas membrane distillation enclosures and a plurality of the condenser enclosures coupled to a plurality of coolant compartments to provide a multistage distillation-multistage condenser configuration.

13. The water desalination system of claim 1, wherein the gas outlet of the jet impingement condenser unit is connected to the air compressor inlet through a heat exchanger.

14. The water desalination system of claim 1, wherein the chiller is a thermoelectric coolant.

15. A water desalination method, comprising:
circulating heated water between a first compartment of the sweeping gas membrane distillation unit and a water heater through a water inlet and a water outlet of the sweeping gas membrane distillation unit;
receiving a carrier gas from an air compressor into a second compartment of the sweeping gas membrane distillation unit;
generating a water vapor from the heated water in the first compartment with a temperature difference between the heated water in the first compartment and the carrier gas in the second compartment of the sweeping gas membrane distillation unit;
passing the water vapor through a hydrophobic surface of a membrane disposed in between the first compartment and the second compartment of the sweeping gas membrane distillation unit;
generating humidified air by heating received carrier gas with the incoming water vapor in the second compartment of the sweeping gas membrane distillation unit;
passing the humidified air through a connector from the sweeping gas membrane distillation unit to a jet impingement condenser unit;
generating a plurality of jets of air from the humidified air through equally spaced perforations on a perforated plate disposed in the jet impingement condenser unit;
cooling a condenser surface disposed in a distal compartment of the jet impingement condenser unit by circulating a cool water stream against the condenser surface, wherein the cool water stream is generated using a chiller; and
cooling the plurality of jets of air in contact with the cooled condenser surface and generating distilled water and dehumidified air.

16. The water desalination method of claim 15, further comprising passing the humidified air through a plurality of sweeping gas membrane distillation units.

17. The water desalination method of claim 15, further comprising passing the distilled water through a plurality of jet impingement condenser units.

18. The water desalination method of claim 15, further comprising passing the humidified air through a plurality of sweeping gas membrane distillation units and passing the distilled water through a plurality of jet impingement condenser units.

19. The water desalination method of claim 15, further comprising passing the dehumidified air to the sweeping gas membrane distillation unit as the incoming air.

20. The water desalination method of claim 19, further comprising performing a heat exchange between the incoming air of the sweeping gas membrane distillation unit and the dehumidified air output of the jet impingement condenser.
